(19) United States
(12) Patent Application Publication
(10) Pub. No.: US 2024/0339842 A1
(43) Pub. Date: Oct. 10, 2024

(54) Secondary frequency modulation method for hydropower plant which satisfies positive correlation between regulation rate and rated capacity of hydropower plant

(71) Applicant: HUANENG LANCANG RIVER HYDROPOWER INC., Kunming City (CN)

(72) Inventors: Ziwei WANG, Kunming City (CN); Shuhong YIN, Kunming City (CN); Lin HU, Kunming City (CN); Wei CHEN, Kunming City (CN); Wangdan NI, Kunming City (CN); Wei HE, Kunming City (CN); Feng HU, Kunming City (CN); Chuan CHEN, Kunming City (CN)

(21) Appl. No.: 18/419,618

(22) Filed: Jan. 23, 2024

Related U.S. Application Data
(63) Continuation of application No. PCT/CN2023/128241, filed on Oct. 31, 2023.

(30) Foreign Application Priority Data
Apr. 6, 2023 (CN) 202310360873.2

(51) Int. Cl. H02J 3/46; F03B 13/00; H02J 3/00

(52) U.S. Cl. CPC H02J 3/46; F03B 13/00; H02J 3/0075; F05B 2220/706

(57) ABSTRACT

A secondary frequency modulation method for a hydropower plant which satisfies positive correlation between a regulation rate and a rated capacity of the hydropower plant, three secondary frequency modulation gain methods are provided, in which feedforward gain regulation and amplification gain regulation call as many hydropower generating units as possible to participate in secondary frequency modulation, and avoid or restrain the problem that the power regulation sensitivity of an active power regulation dead zone of a single hydropower generating unit is weakened; transfer gain regulation transfers the regulation margin of the hydropower generating unit not participating in the secondary frequency modulation to the hydropower generating unit participating in the secondary frequency modulation within the limit of the active power regulation dead zone of a single hydropower generating unit, so that the latter can obtain a larger active power regulation range.

### TECHNICAL FIELD

The invention relates to the technical field of power system automation control, in particular to a secondary frequency modulation method for a hydropower plant which satisfies positive correlation between a regulation rate and a rated capacity of the hydropower plant.

### BACKGROUND ART

The grid frequency reflects the balance between the generated power and consumed power of the power system. When the generated power is higher than the consumed power, the grid frequency is higher than the rated frequency (50 Hz); when the generated power is lower than the consumed power, the grid frequency is lower than the rated frequency. Taking the grid frequency as the reference index, the power system makes the generated power and the consumed power return to the balanced state by regulating the two; the main regulation modes are primary frequency modulation and secondary frequency modulation for the generated power.

Secondary frequency modulation means that when the deviation between the grid frequency and the rated frequency exceeds the secondary frequency modulation threshold value, the dispatching mechanism regulates the output active power of each grid-connected power plants within the control range, so that the generated power and the consumed power of the grid can restore the balanced state to ensure that the difference between the grid frequency and the rated frequency is within the allowable range. Secondary frequency modulation includes the following steps: 1) The dispatching mechanism calculates the generated power change required to restore the grid frequency to the rated frequency according to the grid frequency deviation and the grid “frequency-power” sensitivity coefficient; 2) The dispatching mechanism corrects the active power set value of each grid-connected power plant according to the calculation results and sends power regulation commands; 3) After each power plant receives the new active power set value, AGC distributes the total active power set value of the power plant to each unit controlled by AGC; 4) The active power control system of each unit performs the active power closed-loop feedback regulation according to the new active power set value of the single unit.

The above whole regulation process of secondary frequency modulation shows that three important factors affecting the regulation quality of secondary frequency modulation are as follows: 1) correct calculation of regulation amount of secondary frequency modulation by dispatching mechanism; 2) reasonable distribution of regulation amount of secondary frequency modulation by dispatching mechanism; 3) accurate and fast execution of secondary frequency modulation command by hydropower plant. The first two factors are directly controlled by the dispatching mechanism, and the last factor is restricted by the professional and operational management level of the hydropower plant. To make up for this problem, the dispatching mechanism indexes and indirectly manages the regulation performance of secondary frequency modulation in the hydropower plant through a series of methods such as “two rules” and “frequency modulation market”, sets three performance indexes of regulation delay, regulation rate and regulation accuracy, among which the regulation delay reflects the lag from sending the secondary frequency modulation command by the dispatching mechanism to the actual change of active power of the hydropower plant; the regulation rate reflects the variation amplitude of the active power per unit time during the active power regulation of the hydropower plant; the regulation accuracy reflects the deviation between the actual active power of the hydropower plant and the active power set value of the hydropower plant sent by the dispatching mechanism after regulation.

To meet the management requirements of the dispatching mechanism for the secondary frequency modulation quality of the hydropower plant, Literature 1 “Active power output control method for automatic power generation of hydropower plant” (application publication No. CN105914795A), Literature 2 “Preprocessing method of active power output control parameters for automatic generation of hydropower plant” (application publication No. CN105811473A), Literature 3 “AGC active power distribution method for hydropower plant based on unit combined output model” (application publication No. CN105870979A), Literature 4 “Multi-unit combined modeling method for hydropower generating unit with a plurality of operating regions” (application publication No. CN106056236A), Literature 5 “AGC Control Strategy for Hydropower Plant Considering Complex Constraints” (Proceedings of the CSEE1, Vol. 37, Issue 19), Literature 6 “AGC Algorithm Design and Regulation Performance Evaluation for Hydropower Plants of China Southern Power Grid” (Hydropower and Pumped Storage, Vol. 3, Issue 5), Literature 7 “Active power control method for hydropower generating unit with single suggested operating region” (application publication No. CN111740452B), and Literature 8 “Active power control method for hydropower generating unit with double suggested operating regions” (application publication No. CN111654068B) respectively analyze and research the active power regulation mechanism of the hydropower plant from different perspectives, and the results can meet the operation requirements of the dispatching mechanism for the response of hydropower plant to the secondary frequency modulation under most working conditions.

However, the above literatures fail to solve the following problem: positive linear correlation between the expected regulation rate of secondary frequency modulation of the hydropower plant and the total rated capacity of the units in generating state in the hydropower plant, that is, the hydropower plant with a larger rated capacity is expected to provide a higher regulation rate of secondary frequency modulation, while a regulation dead zone for the single active power regulation of the hydropower plant must be set due to its nature of closed-loop regulation to ensure that the end conditions for active power regulation can be achieved. The conflict between the two is that if the hydropower plant allocates the regulation amount of secondary frequency modulation to multiple units for regulation when a larger number of units are turned on and the regulation amount of secondary frequency modulation sent by the dispatching mechanism is smaller, the change of the single active power set value of each unit will be small, which may cause the single active power actual value of each unit to be still within the range of regulation dead zone of the single active power set value, resulting in failure to realize the regulation effect of secondary frequency modulation or weakening of the regulation effect of secondary frequency modulation; however, if the hydropower plant allocates the regulation amount of secondary frequency modulation to a single unit for regulation, most units cannot participate in secondary frequency modulation, which will also cause large deviation between the regulation rate of secondary frequency modulation and the dispatching expectation, thus reducing the regulation performance of secondary frequency modulation. In engineering practice, the regulation performances of secondary frequency modulation of the hydropower plants in Lancang river basin, especially the regulation rate, significantly decrease to different extent from mid-July to mid-November every year.

Therefore, how to effectively control all hydropower generating units in generating state to participate in secondary frequency modulation or control part of hydropower generating units in generating state to participate in secondary frequency modulation at a faster rate under the conditions that the number of hydropower plants turned on is large and the regulation amount of secondary frequency modulation command sent by the dispatching mechanism is small to meet the performance requirements for the regulation rate, regulation delay and regulation accuracy of secondary frequency modulation, is still a problem to be solved.

### Content of Invention

The invention provides a secondary frequency modulation method for a hydropower plant which satisfies positive correlation between a regulation rate and a rated capacity of the hydropower plant, which can control all hydropower generating units in generating state and under AGC control to participate in regulation or control part of hydropower generating units in generating state and under AGC control to participate in regulation at a faster rate upon receiving a secondary frequency modulation dispatching command to achieve higher regulation rate, lower regulation delay and better regulation accuracy.

To achieve the above purpose, the invention adopts the following technical proposal:

A secondary frequency modulation method for a hydropower plant which satisfies positive correlation between a regulation rate and a rated capacity of the hydropower plant includes the following steps: when the power plant receives the secondary frequency modulation command, judge whether the secondary frequency modulation to be performed meets a certain time interval, whether the regulation amplitude exceeds a certain proportion of the total fixed capacity and whether the current active operating interval of the operating AGC hydropower generating unit meets the secondary frequency modulation command, and set the secondary frequency modulation gain regulation mark to reflect the judgment result; when the judgment conditions are satisfied, carry out the secondary frequency modulation by means of gain regulation;

The gain adjustment is feedforward gain adjustment: add an open-loop regulation link before the single active power closed-loop adjustment process; send an increased or decreased active power relay pulse command with a certain length during open-loop regulation according to the regulation amount of secondary frequency modulation;

Alternatively, the gain regulation is amplification gain regulation: based on the single active power assigned value, amplify the actual regulation amount of single active power closed-loop adjustment according to the single active power regulation dead zone multiplied by a certain ratio parameter;

Alternatively, the gain regulation is transfer gain regulation: divide operating AGC hydropower generating units into a unit participating in secondary frequency modulation and a unit not participating in secondary frequency modulation, and adjust the single active power set value of the latter to make the former obtain a larger active power regulation amplitude.

Compared with the prior art, the invention has the following beneficial technical effects:
1. The invention provides three secondary frequency modulation gain methods, in which feedforward gain regulation and amplification gain regulation call as many hydropower generating units as possible to participate in secondary frequency modulation, and avoid or restrain the problem that the power regulation sensitivity of an active power regulation dead zone of a single hydropower generating unit is weakened; transfer gain regulation transfers the regulation margin of the hydropower generating unit not participating in the secondary frequency modulation to the hydropower generating unit participating in the secondary frequency modulation within the limit of the active power regulation dead zone of a single hydropower generating unit, so that the latter can obtain a larger active power regulation range. Under the mechanisms of feedforward gain regulation and amplification gain regulation, if more units are in generating state, more units will participate in secondary frequency regulation, and the regulation rate will be accordingly faster; however, under the mechanism of transfer gain regulation, if more units are in generating state, the regulation margin which can be transferred will be larger, and the regulation amplitude of the hydropower generating unit participating in secondary frequency modulation will be larger, thereby obtaining the higher regulation rate under the mechanism of active power closed-loop regulation; therefore, compared with the commonly used active power regulation method, the invention can better meet the expectation that the regulation rate is positively correlated with the rated capacity of the hydropower plant.
2. In the invention, strict starting regulation is set for the secondary frequency modulation gain regulation, which can be performed only when the secondary frequency modulation command is received for the first time, the regulation amplitude of secondary frequency modulation is small and no hydropower generating unit requires change to the operation interval, thereby effectively avoiding the possible conflict between the logic of the invention and other conventional logic of the active power regulation function of the hydropower plant, and improving the safety and easy popularization of the invention.
3. In the invention, the calibration regulation of secondary frequency modulation is set to effectively avoid the problem of decreased regulation accuracy caused by the increase of regulation rate and further reduce the regulation error based on the active power regulation function of the original hydropower plant.

### DESCRIPTION OF DRAWINGS

FIG. 1 is the flow diagram for the active power regulation of the hydropower plant in the invention;

FIG. 2 is the simulation model for the feedforward gain regulation of the invention;

FIG. 3 is the logical flow chart for the feedforward gain regulation of the invention;

FIG. 4 is the comparison simulation model for the feedforward gain regulation of the invention and the conventional active power closed-loop regulation;

FIG. 5-1 and FIG. 5-2 are the comparison diagrams for the simulation adjustment effects of the feedforward gain regulation of the invention and the conventional active power closed-loop regulation in different regulation amounts respectively;

FIG. 6 is the simulation model for the amplification gain regulation of the invention;

FIG. 7 is the logical flow chart for the amplification gain regulation of the invention;

FIG. 8 is the comparison simulation model for the amplification gain regulation of the invention and the conventional active power closed-loop regulation;

FIG. 9-1 and FIG. 9-2 are the comparison diagrams for the simulation adjustment effects of the amplification gain regulation of the invention and the conventional active power closed-loop regulation in different regulation amounts respectively;

FIG. 10 is the simulation model for the transfer gain regulation of the invention;

FIG. 11 is the logical flow chart for the transfer gain regulation of the invention;

FIG. 12 is the comparison simulation model for the transfer gain regulation of the invention and the conventional active power closed-loop regulation;

FIG. 13 is the simulation model for the calibration regulation of secondary frequency modulation of the invention;

FIG. 14 is the logical flow chart for the calibration regulation of secondary frequency modulation of the invention;

FIG. 15-1, FIG. 15-2 and FIG. 15-3 respectively show the simulation regulation effects of the single active power set value, single active power actual value and plant active power actual value for the conventional regulation of secondary frequency modulation supplemented by the calibration regulation of secondary frequency modulation of the invention;

FIG. 16 is the simulation model of the transfer gain regulation of secondary frequency modulation supplemented of the invention by the calibration regulation;

FIG. 17 shows the simulation regulation effect of the transfer gain regulation of secondary frequency modulation supplemented of the invention supplemented by the calibration regulation.

### EMBODIMENTS

The invention is further described in detail in conjunction with the drawings.

A secondary frequency modulation method for a hydropower plant which satisfies positive correlation between a regulation rate and a rated capacity of the hydropower plant includes the following steps: when the power plant receives the secondary frequency modulation command, judge whether the secondary frequency modulation to be performed meets a certain time interval, whether the regulation amplitude exceeds a certain proportion of the total fixed capacity and whether the current active operating interval of the operating AGC hydropower generating unit meets the secondary frequency modulation command, and set the secondary frequency modulation gain regulation mark to reflect the judgment result; when the judgment conditions are satisfied, carry out the secondary frequency modulation by means of gain regulation;

The gain adjustment is feedforward gain adjustment: add an open-loop regulation link before the single active power closed-loop adjustment process; send an increased or decreased active power relay pulse command with a certain length during open-loop regulation according to the regulation amount of secondary frequency modulation;

Alternatively, the gain regulation is amplification gain regulation: based on the single active power assigned value, amplify the actual regulation amount of single active power closed-loop adjustment according to the single active power regulation dead zone multiplied by a certain ratio parameter;

Alternatively, the gain regulation is transfer gain regulation: divide operating AGC hydropower generating units into a unit participating in secondary frequency modulation and a unit not participating in secondary frequency modulation, and adjust the single active power set value of the latter to make the former obtain a larger active power regulation amplitude.

The judgment of secondary frequency modulation gain regulation and the methods of secondary frequency modulation gain regulation are described in detail below.

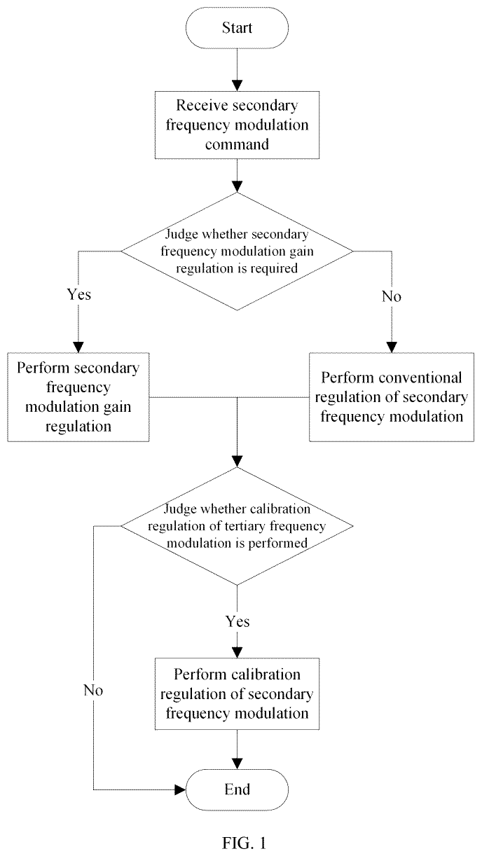

As shown in FIG. 1, the secondary frequency modulation method for the hydropower plant provided by the invention, which satisfies positive correlation between the regulation rate and the rated capacity of the hydropower plant, can be performed by the following steps:
S1000) Judge whether gain regulation is required for the secondary frequency modulation command, including:
S1100) Set the time interval threshold T for starting the secondary frequency modulation gain regulation;
S1200) When the secondary frequency modulation command is received, calculate the time interval between the secondary frequency modulation command and the last secondary frequency modulation command, including:
S1210) Set the timer C1 for continuous timing;
S1220) When a new secondary frequency modulation command is received, perform the following steps:
S1221) Read the time t₁ of the timer C1, and t₁ is the time interval between the current second frequency modulation command and the last second frequency modulation command;
S1222) Reset the timer C1.
S1300) Calculate the regulation amplitude threshold for initiating the secondary frequency modulation gain regulation, including:
S1310) Set the ratio k₁ of the regulation amplitude threshold to the total rated capacity to be greater than or equal to the active power regulation accuracy of the hydropower plant, which is assumed to be 2% in the embodiment;
S1320) Calculate the total rated capacity of the units in generating state in the hydropower plant, and the total rated capacity is equal to the sum of the rated capacities of the hydropower generating units in generating state at the current head; assuming that two units of the hydropower plant are in generating state, the rated capacities are respectively 300 MW and 200 MW, the total rated capacity of the units in generating state in the hydropower plant is 500 MW;
S1330) The regulation amplitude threshold of the secondary frequency modulation gain regulation is equal to the total rated capacity of the units in generating state in the hydropower plant multiplied by k₁; assuming that k₁ is 2% and the total rated capacity of the units in generating state in the hydropower plant is 500 MW, the regulation amplitude threshold of the secondary frequency modulation gain regulation is equal to 500×2%=10 MW.
S1400) Calculate whether the regulation amplitude of the secondary frequency modulation command exceeds the regulation amplitude threshold calculated in S1300, including:
S1410) Calculate the absolute deviation between the plant active power set value and the original plant active power set value of the hydropower plant; assuming that the secondary frequency modulation command sent by the dispatching mechanism is the newly set plant active power set value, which is 1200 MW, and the plant active power set value is 1000 MW before the hydropower plant receives the secondary frequency modulation command, the absolute deviation between the two is 200 MW;
S1420) Calculate the absolute deviation between the plant active power set value and the plant active power actual value of the hydropower plant; assuming that the secondary frequency modulation command sent by the dispatching mechanism is the newly set plant active power set value, which is 1200 MW, and the plant active power actual value is 990 MW before the hydropower plant receives the secondary frequency modulation command, the absolute deviation between the two is 210 MW;
S1430) If the results obtained in S1410 and S1420 are greater than the regulation amplitude threshold calculated in S1300, the regulation amplitude of the secondary frequency modulation command exceeds the regulation amplitude threshold;
S1440) If the results obtained in S1410 and S1420 are less than or equal to the regulation amplitude threshold calculated in S1300, the regulation amplitude of the secondary frequency modulation command does not exceed the regulation amplitude threshold.
S1500) Judge whether the current active operation interval of each hydropower generating unit having AGC put into operation meets the secondary frequency modulation command, including:
S1510) Sum the single active power set values of all hydropower generating units having no AGC put into operation; assuming that two units are not under AGC control, and the single active power set values are respectively 200 MW and 250 MW, the sum of single active power set values of the hydropower generating units having no AGC put into operation is 450 MW;
S1520) Sum the upper limits of the active operation interval for each hydropower generating unit having AGC put into operation; assuming that three units have AGC put into operation, and the upper limits of the active operation interval are respectively 250 MW, 250 MW and 600 MW, the summation result of the upper limits is 1100 MW;
S1530) Sum the lower limits of the active operation interval for each hydropower generating unit having AGC put into operation; assuming that three units have AGC put into operation, and the lower limits of the active operation interval are respectively 100 MW, 100 MW and 400 MW, the summation result of the upper limits is 600 MW;
S1540) Sum the results obtained in S1510 and S1520 to obtain the upper threshold of secondary frequency modulation of the hydropower plant under the constraint of not changing the unit active operation interval; according to the assumptions of S1510 and S1520, the upper threshold of secondary frequency modulation of the hydropower plant under the constraint of not changing the unit active operation interval is 1550 MW;
S1550) Sum the results obtained in S1510 and S1530 to obtain the lower threshold of secondary frequency modulation of the hydropower plant under the constraint of not changing the unit active operation interval; according to the assumptions of S1510 and S1530, the lower threshold of secondary frequency modulation of the hydropower plant under the constraint of not changing the unit active operation interval is 1050 MW;
S1560) If the secondary frequency modulation command is less than or equal to the upper threshold obtained in S1540 and greater than or equal to the lower threshold obtained in S1550, the current active operation interval of each operating AGC hydropower generating unit meets the secondary frequency modulation command;
S1540) If the secondary frequency modulation command is greater than the upper threshold obtained in S1540 and less than the lower threshold obtained in S1550, the current active operation interval of each hydropower generating unit having AGC put into operation does not meet the secondary frequency modulation command.

According to the logic in S1500, if the current active operation interval of each unit in the hydropower plant does not meet the secondary frequency modulation command of the dispatching mechanism, the secondary frequency modulation gain regulation cannot be triggered even if the regulation amplitude of the secondary frequency modulation command is very small. The logic is to majorly change the single active power set value of the unit in the active operation interval if the active operation interval of the unit is not changed at small regulation amplitude of secondary frequency modulation; moreover, the change will exceed the regulation amplitude of the secondary frequency modulation command; in order not to overshoot, the single active power set values of other units that the active operation interval is not changed should be changed in the opposite direction to ensure that the sum of single active power set values of the units is equal to the secondary frequency modulation command received by the hydropower plant, resulting in extremely complex regulation conditions. In this case, if the relevant logic mechanism of secondary frequency modulation gain regulation is introduced, unforeseen regulation conflicts or other exceptions may be caused, it is necessary to set the logic in S1500 and consider whether the current active operation interval of each hydropower generating unit having AGC put into operation meets the secondary frequency modulation command as one of the constraint conditions for the secondary frequency modulation gain regulation.
S1600) Judge whether the conditions for the secondary frequency modulation gain regulation are met, including:
S1610) As mentioned in S1400, judge whether the regulation amplitude of the secondary frequency modulation command exceeds the regulation amplitude threshold; if not, the condition is met; if any, the condition is not met;
S1620) Determine the time interval t1 between the secondary frequency modulation command obtained in S1200 and the last secondary frequency modulation command exceeds the time interval threshold T; if any, the condition is met; if not, the condition is not met;
S1630) As mentioned in S1500, determine whether the current active operation interval of each hydropower generating unit having AGC put into operation meets the secondary frequency modulation command; if any, the condition is met; otherwise, the condition is not met;
S1640) If the conditions in S1610, S1620 and S1630 are met, the conditions for the secondary frequency modulation gain regulation are met; otherwise, the conditions for the secondary frequency modulation gain regulation are not met.
S1700) If the conditions for the secondary frequency modulation gain regulation are not met, perform the conventional regulation of secondary frequency modulation, that is, the AGC of the hydropower plant distributes the regulation amount of secondary frequency modulation command to each hydropower generating unit under AGC control in a conventional way, and then each hydropower generating unit carries out the conventional single active power closed-loop regulation; meanwhile, set the secondary frequency modulation gain regulation mark α to 0;
S1800) If the conditions for the secondary frequency modulation gain regulation are met, perform the secondary frequency modulation gain regulation by the method of the invention, and set the secondary frequency modulation gain regulation mark α to 1.
S2000) Select from three optional secondary frequency modulation gain regulation modes and initiate gain regulation, including:
S2100) Set the feedforward gain regulation, insert the open-loop regulation link before the conventional single active power closed-loop regulation process, and send an increased or reduced active power relay pulse command with a certain length according to the regulation amount of secondary frequency;
S2200) Set the amplification gain regulation, and amplify the actual regulation amount of single active power closed-loop regulation according to the single active power regulation dead zone;
S2300) Set the transfer gain regulation, divide hydropower generating units having AGC put into operation into units participating in secondary frequency modulation and units not participating in secondary frequency modulation, and make the former obtain a larger active power regulation amplitude by adjusting the single active power set value of the latter.
S2400) The three secondary frequency modulation gain regulation modes have their own advantages and disadvantages, in which the feedforward gain regulation and the amplified gain regulation can call more hydropower generating units to participate in secondary frequency modulation than the transfer gain regulation, but the logic complexity of single active power closed-loop regulation and single active power set value determination is increased respectively; the transfer gain regulation only optimizes the distribution method of single active power set value, and has the minimum possibility of conflict with other active power regulation functions or minimum difficulty of promotion and implementation by embedding existing active power regulation functions in the three gain regulation modes. Therefore, the hydropower plant should choose one of the three regulation modes in S2100 to S2300 as the logical mechanism for the secondary frequency modulation gain regulation of the hydropower plant according to the actual operating conditions of the equipment and the compatibility of the existing automation control logic, and adjust according to the preset logic when the secondary frequency modulation gain regulation is required. Each gain regulation mode is described below.

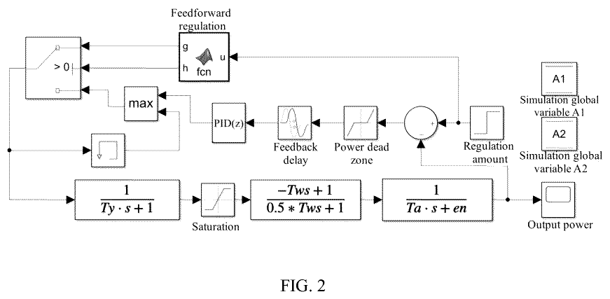

The simulation model for the feedforward gain regulation is shown in FIG. 2, in which T_{y} is the response time constant of the relay; T_{w} is the inertia time constant of water flow; Tₐ is the inertia time constant of the unit (load); T_{f} is the regulation feedback delay, reflecting the synchronization delay between the output power and the PID regulation signal, including output power measurement, transmission time and PID operation time; eₙ is the static frequency self-regulation coefficient of the unit (load).

The feedforward gain regulation is to equally distribute the difference between the plant active power set value of the secondary frequency modulation command and the original plant active power set value of the hydropower plant to each hydropower generating unit participating in the secondary frequency modulation to obtain the regulation amount of secondary frequency modulation; then obtain the single active power set value of each unit according to the original single active power set value;

Each unit first performs open-loop gain regulation according to the received single active power set value, the secondary frequency modulation gain regulation mark and the regulation amount of secondary frequency modulation: sends an increased or decreased active power relay pulse command with a certain length;

Then each unit performs single active power closed-loop regulation according to the single active power actual value and the single active power set value.

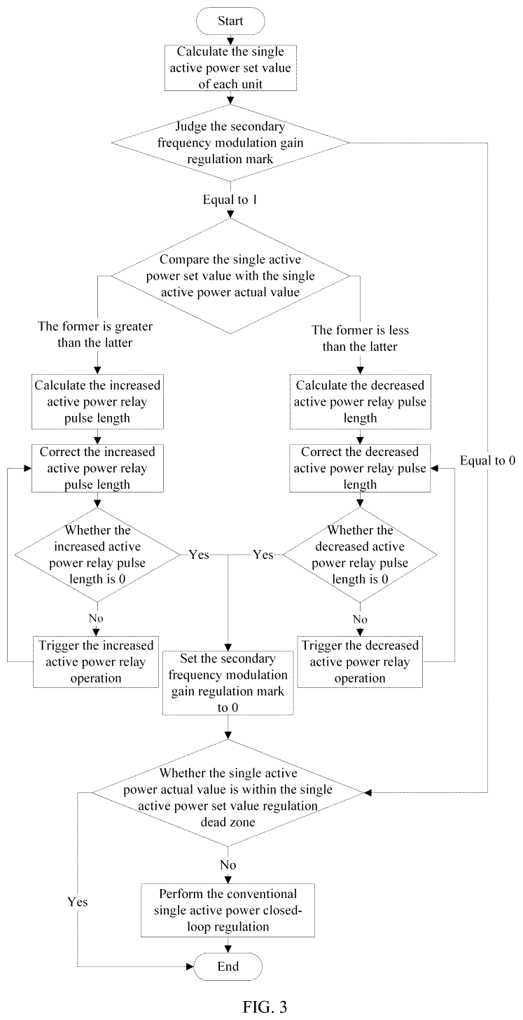

Further, as shown in FIG. 3, the feedforward gain regulation in S3000) can be performed by the following steps:
S3100) Calculate the single active power set value of each hydropower generating unit pᵢ^{set}, including:
S3110) Calculate the difference ΔP between the plant active power set value of the second frequency modulation command and the original plant active power set value of the hydropower plant, where ΔP is equal to the plant active power set value of the second frequency modulation command minus the plant active power set value;
S3120) Calculate the regulation amount Δpᵢ of secondary frequency modulation distributed to each unit, and Δpᵢ is the regulation amount of secondary frequency modulation distributed to the unit i, including:
S3121) If ΔP is greater than 0, Δpᵢ is equal to ΔP divided by the number of units that are under AGC control, in generating state, and the single active power set value is less than the upper limit of the active operation interval;

S3122) If ΔP is less than 0, Δpᵢ is equal to ΔP divided by the number of units that are under AGC control, in generating state, and the single active power set value is greater than the lower limit of the active operation interval;
S3130) Calculate the single active power set value pᵢ^{set} of each unit, including:
S3131) If the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S3132) If the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit).
S3140) Sum the single active power set values of all units to obtain the updated original plant active power set value of the hydropower plant;
S3150) Recalculate ΔP by the method in S3110:
S3151) If ΔP is not equal to 0, go to Step S3120 to perform the distribution calculation of the regulation amount of secondary frequency modulation again;
S3152) If ΔP is equal to 0, end the distribution calculation of the regulation amount of secondary frequency, and obtain the single active power set value pᵢ^{set} of each hydropower generating unit.

Assuming that a total of 5 units in the hydropower plant are in generating state are under AGC control, the single active power set values are respectively 295, 290, 280, 295 and 295 MW, the active operation interval is 100-300 MW, and the plant active power set value of the secondary frequency modulation command newly received from the dispatching mechanism is 1495 MW, the process for calculating the single active power set value pᵢ^{set} of each unit according to the logic in S3100 of the invention is shown in the following table:

| | Before | First | Second | Third |
|---|---|---|---|---|
| Unit/MW | distribution | distribution | distribution | distribution |
| Single active | 295 | 300 | 300 | 300 |
| power set value | | | | |
| of unit 1 | | | | |
| Single active | 290 | 298 | 300 | 300 |
| power set value | | | | |
| of unit 2 | | | | |
| Single active | 280 | 288 | 292.5 | 295 |
| power set value | | | | |
| of unit 3 | | | | |
| Single active | 295 | 300 | 300 | 300 |
| power set value | | | | |
| of unit 4 | | | | |
| Single active | 295 | 300 | 300 | 300 |
| power set value | | | | |
| of unit 5 | | | | |
| Plant active | 1455 | 1486 | 1492.5 | 1495 |
| power set value | | | | |
| ΔP | 40 | 9 | 2.5 | 0 |
| Number of units | 5 | 2 | 1 | 1 |
| participating in | | | | |
| distribution | | | | |
| Δpᵢ | 8 | 4.5 | 2.5 | 0 |

S3200) Send the single active power set value pᵢ^{set} of each hydropower generating unit to the control system of each unit;
S3300) Each unit performs feedforward gain regulation according to the received single active power set value pᵢ^{set}, including:
S3320) Calculate the output pulse length of the feedforward gain regulation according to the secondary frequency modulation gain regulation mark α, including:
S3321) If α is equal to 1 and pᵢ^{set} is greater than pᵢ, calculate the increased active power relay pulse length tᵤ, where tᵤ=γ+(pᵢ^{set}−pᵢ)×k₂;

Wherein, pᵢ is the single active power actual value of the unit i, k2 is the manually set ratio parameter, γ is the minimum effective pulse length of the equipment.
S3322) If α is equal to 1 and pᵢ^{set} is less than pᵢ, calculate the decreased active power relay pulse length t_{d}, where t_{d}=γ+(pᵢ−pᵢ^{set})×k₂;
S3323) If α is equal to 0, perform the conventional single active power closed-loop regulation instead of feedforward gain regulation.
S3330) Control the output relay operation, including:
S3331) When tᵤ is greater than 0, trigger the increased active power relay operation;
S3332) When t_{d} is greater than 0, trigger the decreased active power relay operation.
S3340) Correct the output pulse length of the feedforward gain regulation in each AGC system operation cycle, including:
S3341) When tᵤ is greater than 0, tᵤ=max(tᵤ−tₛ, 0), where tₛ is the operation cycle time of the AGC system;
S3342) When t_{d} is greater than 0, t_{d}=max(t_{d}−tₛ, 0);
S3343) If tᵤ is greater than 0 and pᵢ≥pᵢ^{set}+pᵢ^{dead}, tu=0, where pᵢ^{dead} is the single active power regulation dead zone of the unit i;
S3344) If t_{d} is greater than 0 and pᵢ<pᵢ^{set}−pᵢ^{dead}, td=0.
S3350) Judge the output pulse length of the feedforward gain regulation in each system operation cycle, including:
S3351) If tᵤ is less than 0 or t_{d} is greater than 0, go to Step S3330 and continue to execute S3330, S3340 and S3350;
S3352) If tᵤ is equal to 0 and t_{d} is equal to 0, end the feedforward gain regulation, set the secondary frequency modulation gain regulation mark α to 0, and continue to execute Step S3400.

In Step S3300, all hydropower generating units in the generating state perform feedforward gain regulation in the same direction as the secondary frequency modulation command, and if more hydropower generating units are in the generating state, the effect of feedforward gain regulation will be more obvious, thus ensuring the positive correlation between the regulation rate of secondary frequency modulation and the rated capacity of the hydropower plant.

S3400) Judge whether the single active power actual value pᵢ of each unit is within the regulation dead zone range of the single active power set value pᵢ^{set}, including:
S3410) If pᵢ≥pᵢ^{set}+pᵢ^{dead} or pᵢ<pᵢ^{set}−pᵢ^{dead}, continue the conventional single active power closed-loop regulation;
S3420) If pᵢ^{set}+pᵢ^{dead}≥pᵢ≥pᵢ^{set}−pᵢ^{dead}, end the single active power closed-loop regulation.

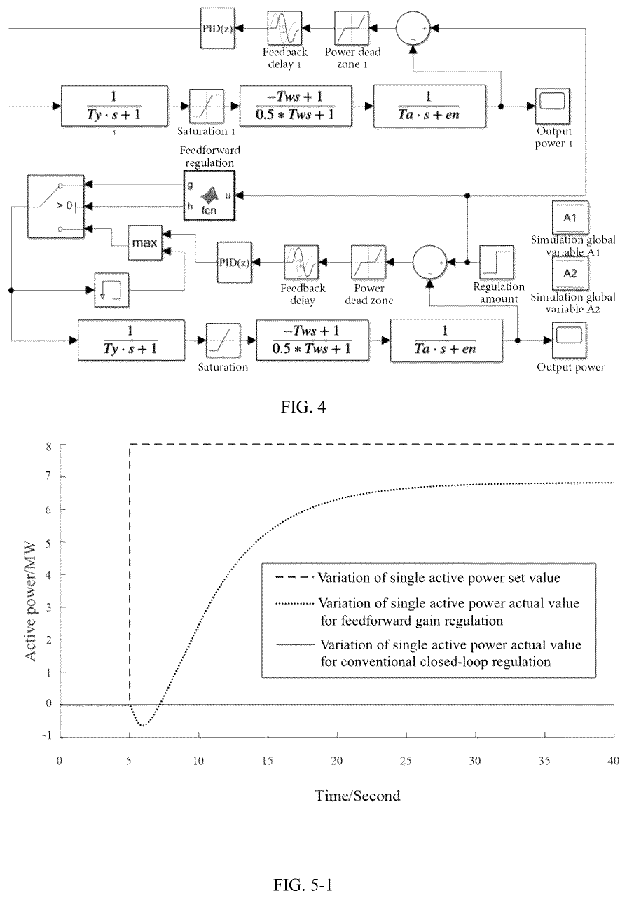

To show the advantages of the invention, the simulation model for the regulation effect comparison between the secondary frequency modulation feedforward gain regulation of the invention and the conventional single active power closed-loop regulation of the hydropower generating unit is shown in FIG. 4, in which T_{y} is the response time constant of the relay; T_{w} is the inertia time constant of water flow; Tₐ is the inertia time constant of the unit (load); T_{f} is the regulation feedback delay, reflecting the synchronization delay between the output power and the PID regulation signal, including output power measurement, transmission time and PID operation time; eₙ is the static frequency self-regulation (characteristic) coefficient of the unit (load).

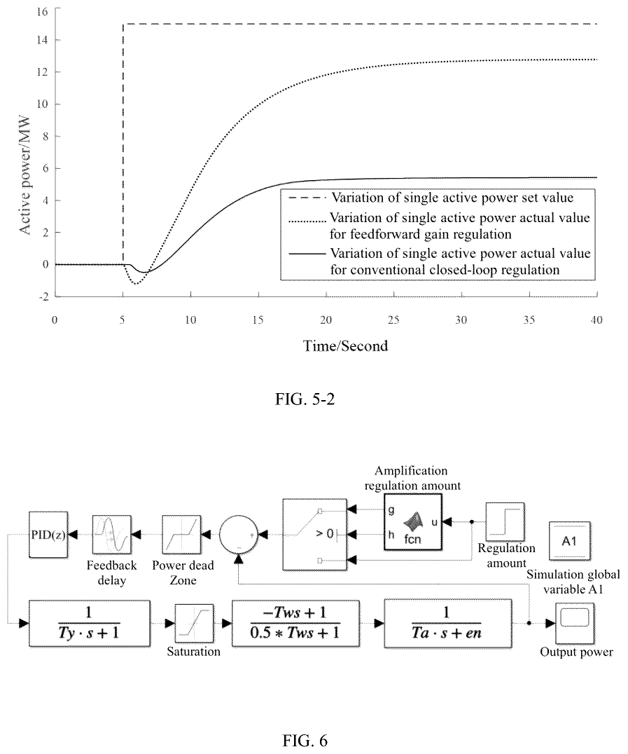

Assuming that the active power regulation dead zone of the unit is 10 MW, the simulation regulation effect of the secondary frequency modulation feedforward gain regulation of the invention and the conventional single active power closed-loop regulation of the hydropower generating unit is shown in FIG. 5-1 and FIG. 5-2 (FIG. 5-1 shows the regulation effect at the regulation amount of 8 MW and FIG. 5-2 shows the regulation effect at the regulation amount of 15 MW) when the regulation amounts are 8 MW and 15 MW. It can be seen from FIG. 5 that the secondary frequency modulation feedforward gain regulation of the invention has obvious effects on ensuring the regulation quality and improving the regulation rate under the condition of small load regulation.

The simulation model for the amplification gain regulation is shown in FIG. 6, in which T_{y} is the response time constant of the relay; T_{w} is the inertia time constant of water flow; Tₐ is the inertia time constant of the unit (load); T_{f} is the regulation feedback delay, reflecting the synchronization delay between the output power and the PID regulation signal, including output power measurement, transmission time and PID operation time; eₙ is the static frequency self-regulation (characteristic) coefficient of the unit (load).

The amplification gain regulation is to equally distribute the difference between the plant active power set value of the secondary frequency modulation command and the original plant active power set value of the hydropower plant to each hydropower generating unit participating in the secondary frequency modulation to obtain the regulation amount of secondary frequency modulation; then obtain the single active power set value of each unit according to the original single active power set value and distribute the single active power set value to each unit;

Within the gain regulation time threshold T₁ shorter than the time interval threshold T, each unit enlarges and updates the regulation amount of the single active power set value based on the single active power assigned value in the same direction, and the enlarged amount is the single active power regulation dead zone multiplied by the set ratio parameter;

Each unit performs single active power closed-loop regulation according to the updated single active power set value; when the amplification gain regulation time reaches the gain regulation time threshold, the current single active power set value is set to the single active power assigned value.

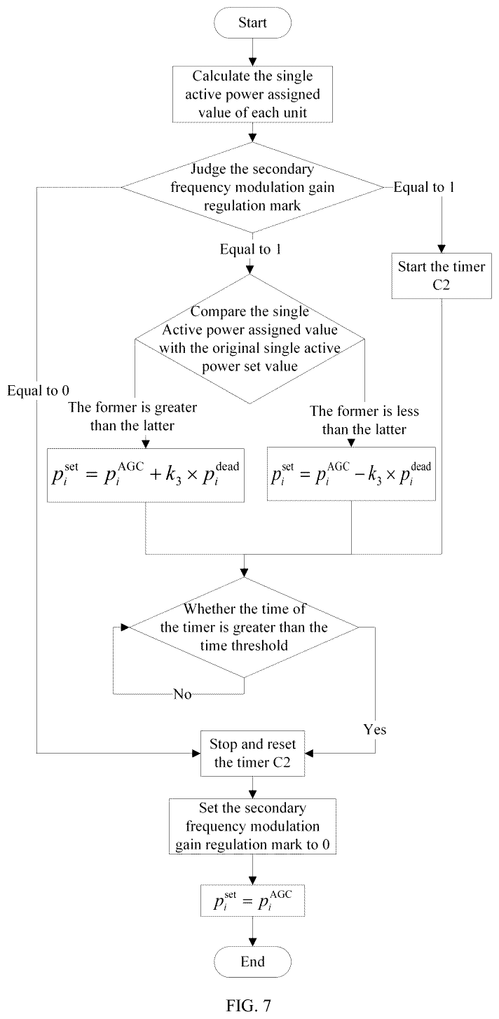

As shown in FIG. 7, the amplification gain regulation in S4000 can be performed by the following steps:
S4100) Calculate the active power assigned value pᵢ^{AGC} of each hydropower generating unit;
S4110) Calculate the difference ΔP between the plant active set value of the secondary frequency modulation command and the original plant active set value of the hydropower plant, and ΔP is equal to the whole plant active set value of the secondary frequency modulation command minus the original plant active set value of the hydropower plant;
S4120) Calculate the regulation amount Δpᵢ of secondary frequency modulation distributed to each unit, and Δpᵢ is the regulation amount of secondary frequency modulation distributed to the unit i, including:
S4121) If ΔP is greater than 0, Δpᵢ is equal to ΔP divided by the number of units that are under AGC control, in generating state, and the single active power set value is less than the upper limit of the active operation interval;
S4122) If ΔP is less than 0, Δpᵢ is equal to ΔP divided by the number of units that are under AGC control, in generating state, and the single active power set value is greater than the lower limit of the active operation interval.
S4130) Calculate the single active power assigned value pᵢ^{AGC} of each unit, including:
S4131) If the single regulation amount Δpᵢ of secondary frequency modulation of the unit i is greater than 0, the single active power assigned value pᵢ^{AGC} is equal to min (the original single active power assigned value+the single regulation amount Δpᵢ of secondary frequency modulation, the upper limit of the active operation interval of the unit);
S4132) If the single regulation amount Δpᵢ of secondary frequency modulation of the unit i is less than 0, the single active power assigned value pᵢ^{AGC} is equal to max (the original single active power assigned value+the single regulation amount Δpᵢ of secondary frequency modulation, the lower limit of the active operation interval of the unit);
S4140) Sum the single active power assigned values of all units to obtain an updated original active power set value of the hydropower plant;
S4150) Recalculate ΔP by the method in S4110:
S4151) If ΔP is not equal to 0, go to Step S4120 to calculate the regulation amount of secondary frequency modulation again;
S4152) If ΔP is equal to 0, end the distribution calculation of the regulation amount of secondary frequency modulation, and obtain the single active power assigned value pᵢ^{AGC} of each hydropower generating unit.

Assuming that a total of five units are in the generating state in the hydropower plant and under AGC control, the single active power assigned values are respectively 295 MW, 290 MW, 280 MW, 295 MW and 295 MW, and the active operation interval is 100-300 MW, the plant active power set value of the secondary frequency modulation command newly received from the dispatching mechanism is 1495 MW, the process for calculating the single active power assigned value pᵢ^{AGC} of each unit according to the logic in S4100 of the invention is shown in the following table.

| | Before | First | Second | Third |
|---|---|---|---|---|
| Unit/MW | distribution | distribution | distribution | distribution |
| Single active | 295 | 300 | 300 | 300 |
| power set value | | | | |
| of unit 1 | | | | |
| Single active | 290 | 298 | 300 | 300 |
| power set value | | | | |
| of unit 2 | | | | |
| Single active | 280 | 288 | 292.5 | 295 |
| power set value | | | | |
| of unit 3 | | | | |
| Single active | 295 | 300 | 300 | 300 |
| power set value | | | | |
| of unit 4 | | | | |
| Single active | 295 | 300 | 300 | 300 |
| power set value | | | | |
| of unit 5 | | | | |
| Plant active | 1455 | 1486 | 1492.5 | 1495 |
| power set value | | | | |
| ΔP | 40 | 9 | 2.5 | 0 |
| Number of units | 5 | 2 | 1 | 1 |
| participating in | | | | |
| distribution | | | | |
| Δpᵢ | 8 | 4.5 | 25 | 0 |

S4200) Send the single active power assigned value pᵢ^{AGC} of each hydropower generating unit to the control system of each unit;
S4300) Each unit performs the amplification gain regulation according to the received single active power assigned value pᵢ^{AGC}, including:
S4310) Set the gain regulation time threshold T₁ for the secondary frequency modulation gain regulation, and the gain regulation time threshold set in S4310 should be less than the time interval threshold T for initiating the secondary frequency modulation gain regulation set in S1100;
If the judgment conditions for the secondary frequency modulation gain regulation are met, set the secondary frequency modulation gain regulation mark α to 1; otherwise, set the secondary frequency modulation gain regulation mark α to 0;
S4320) Set a timer C2 to time the amplification gain regulation time for the secondary frequency modulation:
S4321) If α is equal to 1, start the timer C2 for timing;
S4322) If α is equal to 0, stop and reset the timer C2;
S4330) Each unit updates the active power set value pᵢ^{set} according to the secondary frequency modulation gain regulation mark a and the received single active power assigned value pᵢ^{AGC}, including:
S4331) If α is equal to 1 and pᵢ^{AGC} is greater than the current pᵢ^{set}, indicating that the increased active power regulation is required for the frequency modulation, further amplify the regulation amount by updating pᵢ^{set}, and update pᵢ^{set} to pᵢ^{set}=pᵢ^{AGC}+k₃×pᵢ^{dead}, where pᵢ^{dead} is the single active power regulation dead zone of the unit i, and k₃ is the manually set ratio parameter greater than or equal to 1;
S4332) If α is equal to 1 and pᵢ^{AGC} is less than pᵢ^{set}, indicating that the decreased active power regulation is required for the frequency modulation, further amplify the regulation amount by updating pᵢ^{set}, and update pᵢ^{set} to pᵢ^{set}=pᵢ^{AGC}−k₃×pᵢ^{dead};
S4333) If α is equal to 0, update pᵢ^{set} to pᵢ^{AGC} for regulation, and pᵢ^{set}=pᵢ^{AGC};

Each unit performs single active power closed-loop regulation according to the updated single active power set value pᵢ^{set};

In Step S4300, all hydropower generating units in the generating state perform the amplification gain regulation in the same direction as the secondary frequency modulation command, and the amplification amount of the active power regulation of each unit in the hydropower plant is calculated by the single active power regulation dead zone and the manually set ratio parameter k3; therefore, if more hydropower generating units are in the generating state, more hydropower generating units will participate in the secondary frequency modulation, and the amplification amplitude of active power regulation of the hydropower plant will be more obvious, thus ensuring the positive correlation between the regulation rate of secondary frequency modulation and the rated capacity of the hydropower plant.

S4340) Take the time t₂ of the timer C2 in each system operation cycle; when t₂ is greater than or equal to the amplification gain regulation time threshold in S4310, stop the timing of the timer C2, and reset the timer C2; set pᵢ^{set}=pᵢ^{AGC}, and set the secondary frequency modulation gain regulation mark α to 0;

Each unit performs single active power closed-loop regulation according to the updated single active power set value pᵢ^{set}.

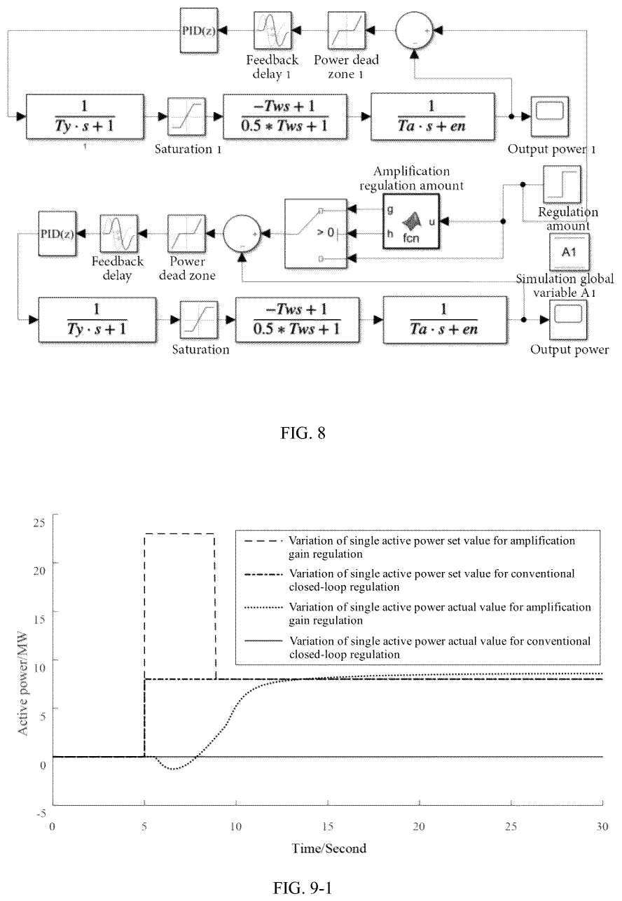

To show the advantages of the invention, the simulation model for the regulation effect comparison between the secondary frequency modulation amplification gain regulation of the invention and the conventional single active power closed-loop regulation of the hydropower generating unit is shown in FIG. 8, in which T_{y} is the response time constant of the relay; T_{w} is the inertia time constant of water flow; Tₐ is the inertia time constant of the unit (load); T_{f} is the regulation feedback delay, reflecting the synchronization delay between the output power and the PID regulation signal, including output power measurement, transmission time and PID operation time; eₙ is the static frequency self-regulation (characteristic) coefficient of the unit (load).

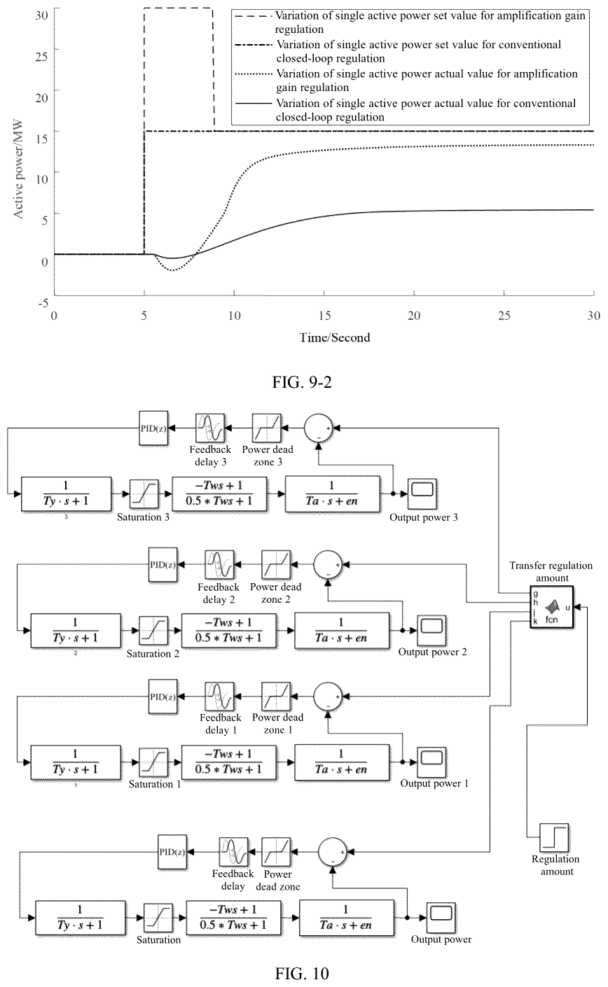

Assuming that the active power regulation dead zone of the unit is 10 MW, k₃ is equal to 1.5, and the time threshold of secondary frequency modulation amplification gain regulation is 4 seconds, the simulation regulation effect comparison between the secondary frequency modulation amplification gain regulation and the conventional single active power closed-loop regulation of the hydropower generating unit is shown in FIG. 9-1 and FIG. 9-2 (FIG. 9-1 shows the regulation effect at the regulation amount of 8 MW, and FIG. 9-2 shows the regulation effect at the regulation amount of 15 MW) when the regulation amounts are 8 MW and 15 MW. It can be seen from FIG. 9-1 and FIG. 9-2 that the secondary frequency modulation amplification gain regulation of the invention has obvious effects on ensuring the regulation quality and improving the regulation rate under the condition of small load regulation.

The simulation model for the transfer gain regulation is shown in FIG. 10, in which T_{y} is the response time constant of the relay; T_{w} is the inertia time constant of water flow; Tₐ is the inertia time constant of the unit (load); T_{f} is the regulation feedback delay, reflecting the synchronization delay between the output power and the PID regulation signal, including output power measurement, transmission time and PID operation time; eₙ is the static frequency self-regulation (characteristic) coefficient of the unit (load).

The transfer gain regulation is to divide operating AGC hydropower generating units into units participating in secondary frequency modulation and units not participating in secondary frequency modulation, and transfer the regulation margin of the hydropower generating units not participating in secondary frequency modulation to the hydropower generating units participating in secondary frequency modulation by adjusting the single active power set value of the units not participating in secondary frequency modulation, and the transferred regulation margin of a single unit is related to the single active power regulation dead zone multiplied by the ratio parameter;

On the premise that the active power set value of the hydropower plant meets the plant active set value of the secondary frequency modulation command, the hydropower generating units participating the secondary frequency modulation obtain the regulation amount of secondary frequency modulation including the transferred regulation margin, and distribute the regulation amount of secondary frequency modulation equally to each hydropower generating units participating the secondary frequency modulation by setting the single active set value;

The single active power set value of each hydropower generating unit is sent to each hydropower generating unit for closed-loop regulation.

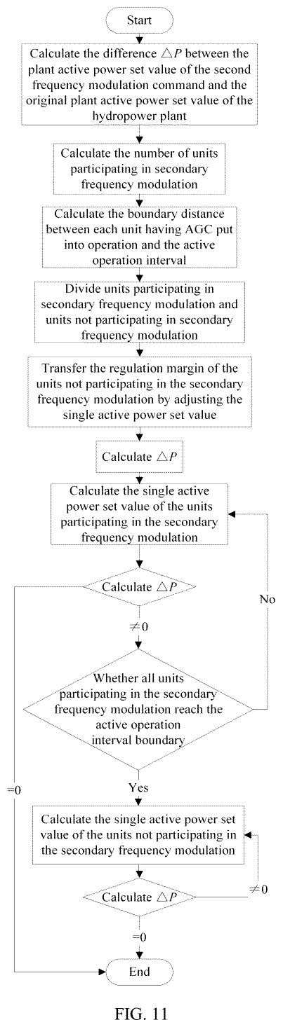

As shown in FIG. 11, the transfer gain regulation in S5000 can be performed by the following steps:
S5100) Calculate the difference ΔP between the plant active power set value of the second frequency modulation command and the original plant active power set value of the hydropower plant, where ΔP is equal to the plant active power set value of the second frequency modulation command minus the plant active power set value;
S5200) Calculate the number m of hydropower generating units participating in the secondary frequency modulation, m approximates |ΔP| divided by the capacity β of segmented unit, where the capacity β of segmented unit is a manually set parameter, and m values as the natural number obtained by dividing the absolute value closest to ΔP by the capacity β of segmented unit; assuming that ΔP is equal to 50 MW and β is equal to 30, |ΔP|÷β=1.67, then m is the natural number 2 closest to 1.67, that is, the number of hydropower generating units participating in secondary frequency modulation is 2.

S5300) Select hydropower generating units participating in the secondary frequency modulation, including:
S5310) Judge ΔP, including:
S5311) If ΔP is greater than 0, calculate the absolute difference between the single active power actual value and the upper limit of the active operation interval for all units having AGC put into operation;
S5312) If ΔP is less than 0, calculate the absolute difference between the single active power actual value and the lower limit of the active operation interval for all units having AGC put into operation.

S5320) Sort all units having AGC put into operation from largest to smallest according to the results obtained in S5310;
S5330) Select the first m units from the units having AGC put into operation according to the sorting result in S5320 as the hydropower generating units participating in the secondary frequency modulation, and take the remaining units as the hydropower generating units not participating in the secondary frequency modulation.

Assuming that a total of five units are in the generating state in the hydropower plant and under AGC control, the single active power assigned values of the units 1-5 are 295 MW, 290 MW, 280 MW, 295 MW and 295 MW in order, and the active operation interval is 100-300 MW, the five units are sorted into units 1, 4, 5, 2 and 3 according to the absolute value of the difference between the single active power actual value and the lower limit of the active operation interval from largest to smallest when ΔP is equal to 50 MW, β is equal to 30 MW and two hydropower generating units participate in secondary frequency modulation, so units 1 and 4 are selected as the hydropower generating units participating in secondary frequency modulation, and units 2, 3 and 5 are selected as the hydropower generating units not participating in secondary frequency modulation.

If the judgment conditions for the secondary frequency modulation gain regulation are met, set the secondary frequency modulation gain regulation mark α to 1; otherwise, set the secondary frequency modulation gain regulation mark α to 0;
S5400) Correct the single active set value pᵢ^{set} of the units having AGC put into operation but not participating in the secondary frequency modulation according to the secondary frequency modulation gain regulation mark α, including:
S5410) If a is equal to 1 and ΔP is greater than 0, correct the single active power set value pᵢ^{set} of the units not participating in the secondary frequency modulation to pᵢ^{set}=max(pᵢ−pᵢ^{dead}×k₄, pᵢ), where pᵢ is the single active power actual value of the unit i, pᵢ^{dead} is the single active power regulation dead zone of the unit i, k₄ is the manually set ratio parameter less than 1 and greater than 0, and pᵢ is the lower limit of the current active operation interval of the unit i;

Assuming that k₄ is equal to 0.8, pᵢ^{dead} is equal to 10 MW, and the single active power actual value is equal to 106 MW, correct pᵢ^{set} to max(pᵢ−pᵢ^{dead}×k₄, pᵢ)=max(106−8, pᵢ)=max(98 MW, pᵢ) regardless of the original single active power set value;
S5420) If α is equal to 1 and ΔP is less than 0, correct the single active power set value pᵢ^{set} of the units not participating in the secondary frequency modulation to pᵢ^{set}=min(pᵢ+pᵢ^{dead}×k₄, p̅ᵢ̅), where p̅ᵢ̅ is the upper limit of the current active operation interval of the unit i;

Assuming that k₄ is equal to 0.8, pᵢ^{dead} is equal to 10 MW, and the single active power actual value is equal to 106 MW, correct pᵢ^{set} to min(pᵢ+pᵢ^{dead}×k₄, p̅ᵢ̅)=max(106+8, p̅ᵢ̅)=min(114 MW, p̅ᵢ̅) regardless of the original single active power set value;
S5430) If α is equal to 0, correct the single active power set value pᵢ^{set} of the units not participating in the secondary frequency modulation to pᵢ^{set}=pᵢ; assuming that the single active power actual value is equal to 106 MW, correct pᵢ^{set} to 106 MW regardless of the original single active power set value.

In S5200, the number of units participating in the secondary frequency modulation is m, and the number of units not participating in the secondary frequency modulation is the number of units in generating state and under AGC control minus m; therefore, if more units are in generating state, more units will not participate in the secondary frequency modulation.

According to S5400, the units not participating in the secondary frequency modulation respectively correct the single active power set value pᵢ^{set} in the gain regulation mode to transfer the regulation margin within the permissible range of the single active power regulation dead zone to the hydropower generating units participating in the secondary frequency modulation through Step S5500 without triggering the single active power closed-loop regulation; therefore, if more units do not participate in the secondary frequency modulation, the sum of the regulation margin transferred in S5400 will be greater, the regulation amount of the hydropower generating units participating in the secondary frequency modulation will be greater when being transferred to the hydropower generating units participating in the secondary frequency modulation through Step S5500, thus ensuring the positive correlation between the regulation rate of secondary frequency modulation and the rated capacity of the hydropower plant.
S5500) Correct the single active power set value pᵢ^{set} of the units having AGC put into operation and participating in the secondary frequency modulation, including:
S5510) Recalculate the original plant active power set value of the hydropower plant, which is equal to the sum of the single active power set values of the units;
S5520) Calculate the difference ΔP between the plant active power set value of the second frequency modulation command and the original plant active power set value of the hydropower plant, where ΔP is equal to the plant active power set value of the second frequency modulation command minus the plant active power set value;
S5530) Calculate the regulation amount Δpᵢ of secondary frequency modulation distributed to the unit i having AGC put into operation and participating in the secondary frequency modulation, where Δpᵢ is the regulation amount of secondary frequency modulation distributed to the units i, including:
S5531) If ΔP is greater than 0, Δpᵢ is equal to ΔP divided by the number of units under AGC control, participating in the secondary frequency modulation, and with the single active power set value less than the upper limit of the active operation interval S5532) If ΔP is less than 0, Δpᵢ is equal to ΔP divided by the number of units under AGC control, participating in the secondary frequency modulation, and with the single active power set value less than the lower limit of the active operation interval.
S5540) Calculate the single active power set value pᵢ^{set} of the units having AGC put into operation and participating in the secondary frequency modulation, including:
S5541) If the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S5542) If the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit).
S5550) Recalculate the original plant active power set value of the hydropower plant, which is equal to the sum of the single active power set values of the units;
S5560) Recalculate ΔP by the method in S5520:
S5561) If ΔP is greater than 0, and the active power set value pᵢ^{set} of the units having AGC put into operation and participating in the secondary frequency modulation is less than the upper limit of the active power operation interval, go to Step S5530 to carry out the distribution calculation of the regulation amount of secondary frequency modulation again;
S5562) If ΔP is less than 0, and the active power set value pᵢ^{set} of a single unit having AGC put into operation and participating in the secondary frequency modulation is greater than the lower limit of the active power operation interval, go to Step S5530 to carry out the distribution calculation of the regulation amount of secondary frequency modulation again;
S5563) If ΔP is greater than 0, and the active power set value pᵢ^{set} of all single units having AGC put into operation and participating in the secondary frequency modulation is greater than or equal to the upper limit of the active power operation interval, go to Step S5600, and calculate the secondary frequency modulation Δpᵢ of the single units distributed to each operating AGC but not participating in the secondary frequency modulation to correct the transfer amount;
S5564) If ΔP is less than 0, and the active power set value pᵢ^{set} of all single units having AGC put into operation and participating in the secondary frequency modulation is less than or equal to the lower limit of the active power operation interval, go to Step S5600, and calculate the secondary frequency modulation Δpᵢ of the single units distributed to each operating AGC but not participating in the secondary frequency modulation to correct the transfer amount;
S5565) If ΔP is equal to 0, end the distribution calculation of secondary frequency modulation, and obtain the single active power set value pᵢ^{set} of each hydropower generating unit having AGC put into operation and participating in the secondary frequency modulation unit;
S5600) Correct the single active set value pᵢ^{set} of the units having AGC put into operation but not participating in the secondary frequency modulation again, including:
S5610) Recalculate the original plant active power set value of the hydropower plant, which is equal to the sum of the single active power set values of the units;
S5620) Calculate the difference ΔP between the plant active power set value of the secondary frequency modulation command and the plant active power set value of the hydropower plant obtained in S5610, where ΔP is equal to the plant active power set value of the second frequency modulation command minus the plant active power set value of the hydropower plant obtained in S5610;
S5630) Calculate the secondary frequency modulation Δpᵢ of the single units distributed to each operating AGC but not participating in the secondary frequency modulation, where Δpᵢ is the regulation amount of secondary frequency modulation distributed to the unit i, including:
S5631) If ΔP is greater than 0, Δpᵢ is equal to ΔP divided by the number of units under AGC control, not participating in the secondary frequency modulation, and with the single active power set value less than the upper limit of the active operation interval;
S5632) If ΔP is less than 0, Δpᵢ is equal to ΔP divided by the number of units under AGC control, not participating in the secondary frequency modulation, and with the single active power set value greater than the lower limit of the active operation interval.

S5640) Calculate the single active set value pᵢ^{set} of the units having AGC put into operation but not participating in the secondary frequency modulation, including:
S5641) If the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S5642) If the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit).
S5650) Recalculate the original plant active power set value of the hydropower plant, which is equal to the sum of the single active power set values of the units;
S5660) Recalculate ΔP by the method in S5620:
S5661) If ΔP is not equal to 0, go to Step S5630 to carry out the distribution calculation of the regulation amount of secondary frequency modulation again;
S5662) If ΔP is equal to 0, end the distribution calculation of secondary frequency modulation, and obtain the single active power set value pᵢ^{set} of each hydropower generating unit having AGC put into operation but not participating in the secondary frequency modulation unit.

Assuming that a total of five units are in the generating state in the hydropower plant and under AGC control, the single active power set values are respectively 300 MW, 290 MW, 280 MW, 300 MW and 300 MW, the single active power actual value is the same as the single active power set value, and the active operation interval is 100-300 MW, so the plant active power set value is 300+290+280+300+300=1470 MW;

Assuming that k₄ is equal to 0.5, pᵢ^{dead} is equal to 10 MW, β is 10 MW, the plant active power set value of the secondary frequency modulation command newly received from the dispatching mechanism is 1488 MW, the number m of hydropower generating units participating in the secondary frequency modulation approximates |ΔP| divided by the capacity β of segmented unit, equal to 18÷10, so the units 2 and 3 participate in the secondary frequency modulation, and the units 1, 4 and 5 do not participate in the secondary frequency modulation.

According to the assumptions in the embodiments, the process for calculating the single active power set value pᵢ^{set} of each unit based on the logic in S5000 of the invention is shown in the following table:

| | Before | | | | |
|---|---|---|---|---|---|
| Unit/MW | distribution | S5400 | S5500 | S5500 | S5600 |
| Single active | 300 | 295 | 295 | 295 | 296 |
| power set value | | | | | |
| of unit 1 | | | | | |
| Single active | 290 | 290 | 300 | 300 | 300 |
| power set value | | | | | |
| of unit 2 | | | | | |
| Single active | 280 | 280 | 296.5 | 300 | 300 |
| power set value | | | | | |
| of unit 3 | | | | | |
| Single active | 300 | 295 | 295 | 295 | 296 |
| power set value | | | | | |
| of unit 4 | | | | | |
| Single active | 300 | 295 | 295 | 295 | 296 |
| power set value | | | | | |
| of unit 5 | | | | | |
| Plant active | 1470 | 1455 | 1481.5 | 1485 | 1488 |
| power set value | | | | | |
| ΔP | 18 | 33 | 6.5 | 3 | 0 |
| Number of units | | 2 | 1 | 3 | 3 |
| participating in | | | | | |
| distribution | | | | | |
| Δpᵢ | | 16.5 | 6.5 | 1 | 0 |

S5700) Send the single active power set value pᵢ^{set} of each hydropower generating unit to the control system of each hydropower generating unit for single active power closed-loop regulation, and set the secondary frequency modulation gain regulation mark α to 0.

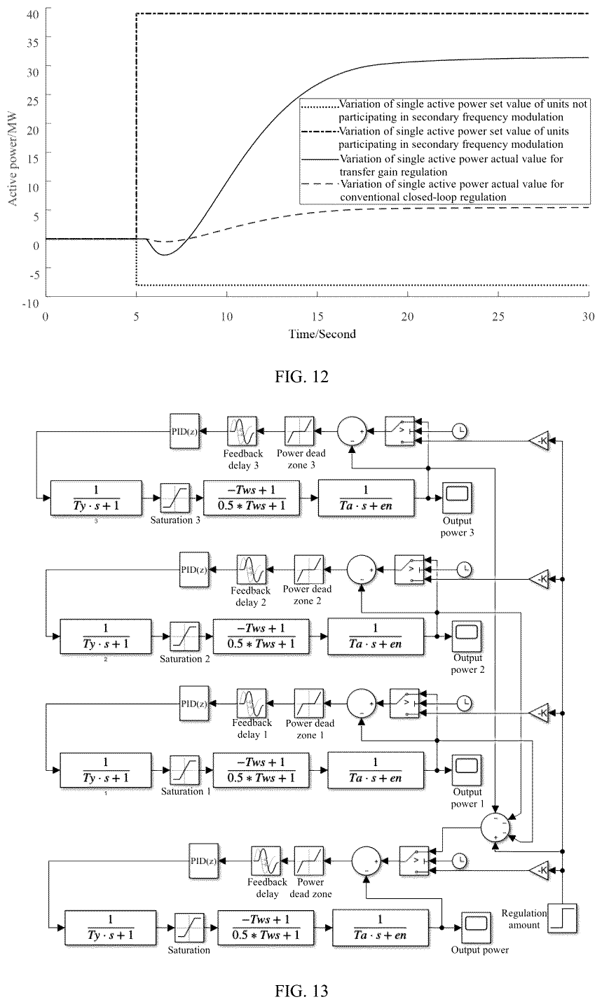

Assuming that the active power regulation dead zone of the unit is 10 MW, k₄ is equal to 0.8, one unit participates in the secondary frequency modulation, and three units do not participate in the secondary frequency modulation, the simulation regulation effect comparison between the gain regulation of secondary frequency modulation and the conventional regulation of secondary frequency modulation (i.e., transfer is not perform, but the regulation amount is simply distributed to the units participating in the secondary frequency modulation) is shown in FIG. 12 when the regulation amount is 15 MW. It can be seen from FIG. 12 that the secondary frequency modulation transfer gain regulation of the invention has obvious effects on increasing the regulation rate and amount under the condition of small load regulation. However, the actual regulation amount of the transfer gain modulation is higher than that of the secondary frequency modulation command due to the transfer of regulation margin, which may cause the problem of increased error within the permissible range of the regulation accuracy. In fact, the problem of increased error may also exist in the feedforward gain modulation and the amplification gain modulation. Therefore, it is necessary to carry out the calibration regulation of secondary frequency modulation in S6000 at the end of the secondary frequency modulation to further reduce the regulation error and improve the regulation accuracy.

The simulation model for the calibration regulation of secondary frequency modulation is shown in FIG. 13, in which T_{y} is the response time constant of the relay; T_{w} is the inertia time constant of water flow; Tₐ is the inertia time constant of the unit (load); T_{f} is the regulation feedback delay, reflecting the synchronization delay between the output power and the PID regulation signal, including output power measurement, transmission time and PID operation time; eₙ is the static frequency self-regulation (characteristic) coefficient of the unit (load).

When the regulation time of secondary frequency modulation of the hydropower plant reaches the calibration time threshold and the number of hydropower generating units with single active power regulation uncompleted is not more than one after the gain regulation, if the error ratio of secondary frequency modulation is greater than the calibration accuracy threshold, carryout the following calibration regulation of secondary frequency modulation:

Select the units with single active power regulation uncompleted or the units with the maximum absolute difference between the single active power set value and the single active power actual value as the units performing the calibration regulation; obtain the single active power pre-assigned value of the units performing calibration regulation by the plant active power set value minus the single active power actual value of all units not performing calibration regulation;

If the obtained active power pre-assigned value of a single unit is greater than or equal to the lower limit of the active operation interval of the unit, and less than or equal to the upper limit of the active operation interval of the unit, set the single active power set value of the unit performing calibration regulation to the single active power pre-assigned value and carry out calibration regulation; otherwise, no calibration regulation is performed.

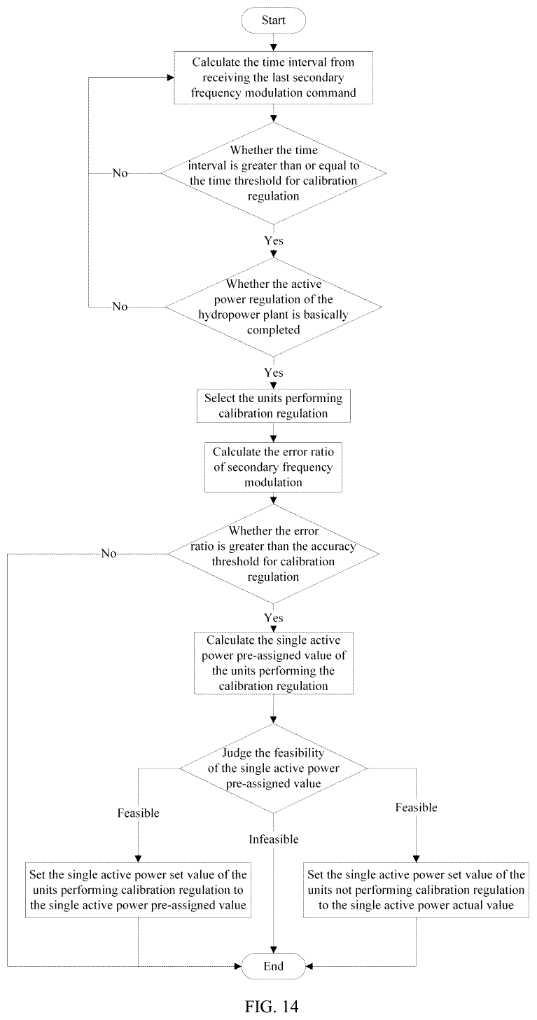

As shown in FIG. 14, the secondary frequency modulation in S6000 can be performed by the following steps:
S6100) Judge whether the time interval from the last receipt of the secondary frequency modulation command is long enough, including:
S6110) Set the calibration regulation time threshold, which is equal to the time required from receiving the secondary frequency modulation command from the hydropower plant to completing the single active power closed-loop regulation for each hydropower generating unit for the first time;
S6120) Read the time t₁ of the timer C1 set in S1200;
S6130) If t₁ is greater than or equal to the time threshold of the calibration regulation, proceed to Step S6200;
S6140) If t₁ is less than the time threshold of the calibration regulation, jump back to Step S6100 and proceed again.
S6200) Judge whether the active power regulation of the hydropower plant is basically completed, including:
S6210) Set a judgment threshold for the completion of single active power regulation, which is equal to the periodic variation of the single active power actual value with random fluctuations after the hydropower generating unit completes the single active power regulation;
S6220) Set an array [Δpᵢ¹, Δpᵢ² . . . Δpᵢⁿ] containing n elements for each unit, where n is the manually set parameter;
S6230) Calculate Δpᵢ¹ in each cycle, where Δpᵢ¹ is equal to the absolute difference between the single active power actual value collected by the unit i in the cycle and the single active power actual value collected in the previous cycle;
S6240) Assign values to all elements of the array in each cycle in turn, so that Δpᵢⁿ=Δpᵢⁿ⁻¹, and Δpᵢⁿ⁻¹=Δpᵢⁿ⁻² . . . Δpᵢ²=Δpᵢ¹;
S6250) After n AGC system cycles, judge whether the single active power of each unit is regulated, including:
S6251) Calculate the weighted average of the array elements for the unit i in S6220,

$$\frac{{\sum }_{i = 1}^{n} Δ {p}_{i}^{j} \times ( n + 1 - j )}{{\sum }_{i = 1}^{n} n + 1 - j} ,$$

where Δpᵢ^{j} is the j^{th} element in the array of the unit i; assuming that the array length set in S6230 is 5, and Δpᵢ¹ to Δpᵢ^{j5} are respectively 10 MW, 10 MW, 20 MW, 20 MW and 10 MW, the calculation result is

$$\frac{10 \times 5 + 10 \times 4 + 20 \times 3 + 20 \times 2 + 10 \times 1}{5 + 4 + 3 + 2 + 1} = \frac{200}{15} \approx 13.3 MW ;$$

S6252) If the result obtained in S6251 is less than the judgment threshold for the completion of single active power regulation set in S6210, the single active power regulation of the unit i is completed;
S6253) If the result obtained in S6251 is greater than the judgment threshold for the completion of single active power regulation set in S6210, the single active power regulation of the unit i is not completed;
S6260) If the number of units not completing the single active power regulation is more than 1, skip back to Step S6100 and proceed again.
S6270) If the number of units not completing the single active power regulation is not more than 1:
S6271) If one unit does not complete the single active power regulation, select the unit to perform calibration regulation, and continue to perform Step S6300;
S6272) If zero unit does not complete the single active power regulation, calculate the absolute difference between the single active power set value and the single active power actual value for the units having AGC put into operation, and select the unit with the maximum absolute difference to perform calibration regulation, and continue to perform Step S6300.
S6300) Judge the regulation accuracy of secondary frequency modulation:
S6310) Set the calibration regulation accuracy threshold to 1.5-0.5%;
S6320) Calculate the absolute difference between the plant active power set value and the plant active power actual value;

Assuming that the plant active power set value is 1000 MW and the plant active power actual value is 1020 MW, the absolute difference between the two is equal to 20 MW;
S6330) Calculate the sum of rated powers of all units in generating state;

Assuming that there are four units for generating, and the single rated power is 500 MW, the total rated power is 2000 MW;
S6340) Calculate the error ratio of secondary frequency modulation, which is equal to the absolute difference in S6320 divided by the sum of rated powers in S6330;

According to the assumptions in S6320 and S6330, the error ratio is 20÷2000=1%;
S6350) Compare the resulting error ratio in S6340 with the calibration accuracy threshold set in S6310, including:
S6351) If the error ratio obtained in S6340 is greater than the accuracy threshold set in S6310, perform Step S6400 for calibration regulation;
S6352) If the error ratio obtained in S6340 is less than or equal to the accuracy threshold set in S6310, end the calibration regulation of secondary frequency modulation.
S6400) Calculate the single active power pre-assigned value of the unit performing calibration regulation, which is equal to the plant active power set value minus the single active power actual value of all units not performing calibration regulation;

Assuming that the plant active power set value is 1000 MW, 4 units are in generating state, the single active power set value is 250 MW, and the single active power actual values are respectively 259 MW, 251 MW, 241 MW and 243 MW, and the unit 1 performs calibration regulation, the single active power pre-assigned value is 1000−251−241−243=265 MW;
S6500) Compare the single active power pre-assigned value of the unit performing calibration regulation obtained in S6400 with the upper and lower limits of the active operation interval for the unit:
S6510) If the single active power pre-assigned value of the unit performing calibration regulation is greater than or equal to the lower limit of the active operation interval of the unit, and less than or equal to the upper limit of the active operation interval of the unit:
S6511) Set the single active power set value pᵢ^{set} of the unit performing calibration regulation to the single active power pre-assigned value;
S6512) Set the single active power set value pᵢ^{set} of the unit not performing calibration regulation to the single active power actual value, namely, pᵢ^{set}=pᵢ, where pᵢ is the single active power actual value of the unit i;
S6513) Send the single active power set value pᵢ^{set} of each hydropower generating unit to the control system of each unit for single active power closed-loop regulation.
S6520) If the single active power pre-assigned value of the unit performing calibration regulation is less than the lower limit of the active operation interval of the unit, or greater than the upper limit of the active operation interval of the unit, indicating that the calibration regulation does not meet the conditions for execution, end the calibration regulation of secondary frequency modulation.

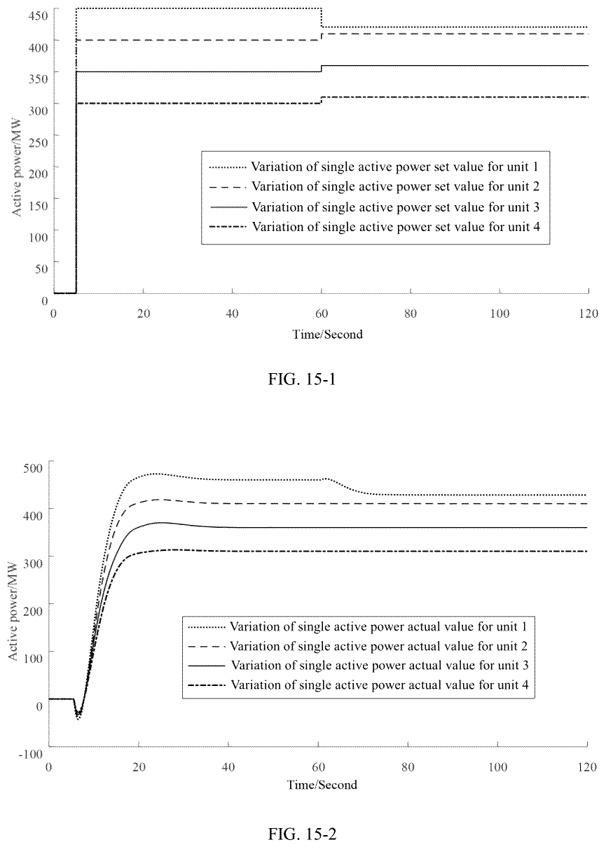

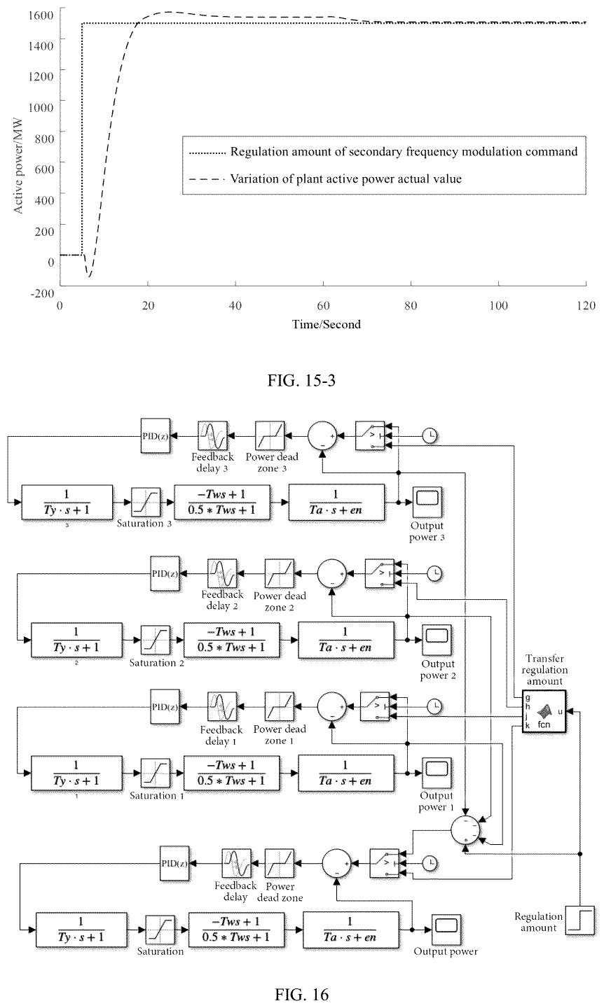

The simulation model shown in FIG. 13 is used to simulate the regulation effect of conventional secondary frequency modulation supplemented by calibration regulation. Assuming that four units participate in regulation, the active power regulation dead zone of the unit is 10 MW, the regulation amount of the secondary frequency modulation command is 1500 MW, and the regulation amounts distributed by the four units are respectively 450 MW, 400 MW, 350 MW and 300 MW, the simulation regulation effects of the single active power set value, the single active power actual value and the plant active power actual value are shown in FIG. 15-1, FIG. 15-2 and FIG. 15-3 respectively.

In addition, to show the advantages of the invention, the simulation model for the secondary frequency modulation transfer gain regulation supplemented by calibration regulation is shown in FIG. 16, in which T_{y} is the response time constant of the relay; T_{w} is the inertia time constant of water flow; Tₐ is the inertia time constant of the unit (load); T_{f} is the regulation feedback delay, reflecting the synchronization delay between the output power and the PID regulation signal, including output power measurement, transmission time and PID operation time; eₙ is the static frequency self-regulation (characteristic) coefficient of the unit (load).

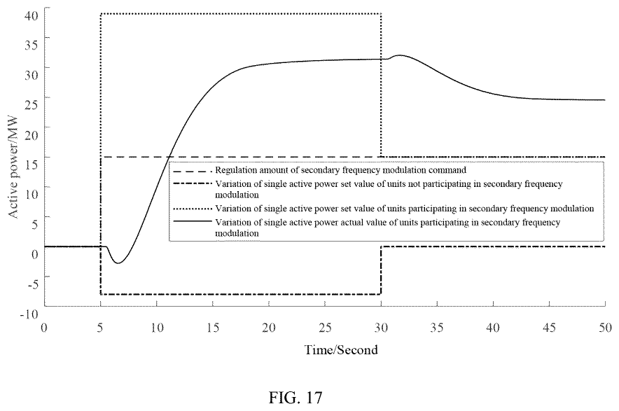

Assuming that the active power regulation dead zone of the unit is 10 MW, k₄ is equal to 0.8, one unit participates in secondary frequency modulation, three units do not participate in secondary frequency modulation, and the regulation amount is 15 MW, first perform the transfer gain regulation and then the calibration regulation for secondary frequency modulation, and the simulation regulation effect is shown in FIG. 17.

It can be seen from FIG. 15-1 to FIG. 15-3 and FIG. 17 that the calibration regulation of secondary frequency modulation of the invention has the effects on obviously reducing the regulation error and improving the regulation accuracy no matter for the secondary frequency modulation gain regulation or the conventional regulation of secondary frequency modulation.

The above shows and describes the basic principle, main features and advantages of the invention. The technicians in the field should understand that the invention is not limited by the above embodiments, the above embodiments and specification only describe the principle of the invention, and various changes and improvements may also be made to the invention without deviating from the spirit and scope of the invention, and fall within the scope of protection of the invention.

What is claimed is:

1. A secondary frequency modulation method for a hydropower plant which satisfies positive correlation between a regulation rate and a rated capacity of the hydropower plant, characterized by including the following steps: when the power plant receives the secondary frequency modulation command, judge whether the secondary frequency modulation to be performed meets a certain time interval, whether the regulation amplitude exceeds a certain proportion of the total fixed capacity and whether the current active operating interval of the operating AGC hydropower generating unit meets the secondary frequency modulation command, and set the secondary frequency modulation gain regulation mark to reflect the judgment result; when the judgment conditions are satisfied, carry out the secondary frequency modulation by means of gain regulation;
the gain adjustment is feedforward gain adjustment: add an open-loop regulation link before the single active power closed-loop adjustment process; send an increased or decreased active power relay pulse command with a certain length during open-loop regulation according to the regulation amount of secondary frequency modulation;
or, the gain regulation is amplification gain regulation: based on the single active power assigned value, amplify the actual regulation amount of single active power closed-loop adjustment according to the single active power regulation dead zone multiplied by a certain ratio parameter;
or, the gain regulation is transfer gain regulation: divide operating AGC hydropower generating units into units participating in secondary frequency modulation and units not participating in secondary frequency modulation, and adjust the single active power set value of the latter to make the former obtain a larger active power regulation amplitude.

2. The secondary frequency modulation method for the hydropower plant which satisfies positive correlation between the regulation rate and the rated capacity of the hydropower plant according to claim 1, characterized in that meeting a certain time interval refers to meeting a time interval threshold:
set the time interval threshold T for starting the secondary frequency modulation gain regulation; if the time interval t₁ exceeds the time interval threshold T, the requirement of a certain time interval is met;
judge whether the regulation amplitude exceeds a certain proportion of the total fixed capacity as follows:
suppose that the ratio of the regulation amplitude threshold to the rated capacity is k₁, and set k₁ to be greater than or equal to the active power regulation accuracy of the hydropower station; calculate the absolute deviation between the plant active power set value and the original plant active power set value of the hydropower plant, and the absolute deviation between the plant active power set value and the plant active power actual value of the hydropower plant; if one of the two results is less than or equal to the total fixed capacity of the units in the generating state in the hydropower plant multiplied by k₁, it is considered that the regulation amplitude of the secondary frequency modulation command does not exceed a certain proportion of the total fixed capacity;
judge whether the current active operation interval of each operating AGC hydropower generating unit meets the secondary frequency modulation command as follows:
if the secondary frequency modulation command is less than or equal to the upper limit of secondary frequency modulation of the hydropower plant under the constraint of not changing the unit active operation interval, and greater than or equal to the lower limit of secondary frequency modulation of the hydropower plant under the constraint of not changing the unit active operation interval, the current active operation interval of each operating AGC hydropower generating unit meets the secondary frequency modulation command;
if the judgment conditions for the secondary frequency modulation gain regulation are met, set the secondary frequency modulation gain regulation mark α to 1; otherwise, set the secondary frequency modulation gain regulation mark α to 0.

3. The secondary frequency modulation method for the hydropower plant which satisfies positive correlation between the regulation rate and the rated capacity of the hydropower plant according to claim 2, characterized in that the feedforward gain regulation is to equally distribute the difference between the plant active power set value of the secondary frequency modulation command and the original plant active power set value of the hydropower plant to each hydropower generating unit participating in the secondary frequency modulation to obtain the regulation amount of secondary frequency modulation; then obtain the single active power set value of each unit according to the original single active power set value;
each unit first performs open-loop gain regulation according to the received single active power set value, the secondary frequency modulation gain regulation mark and the regulation amount of secondary frequency modulation: sends an increased or decreased active power relay pulse command with a certain length;
then each unit performs single active power closed-loop regulation according to the single active power actual value and the single active power set value.

4. The secondary frequency modulation method for the hydropower plant which satisfies positive correlation between the regulation rate and the rated capacity of the hydropower plant according to claim 2, characterized in that the feedforward gain regulation includes the following operating steps:
S3100) calculate the single active power set value of each hydropower generating unit pᵢ^{set};
S3110) subtract the plant active power set value of the secondary frequency modulation command from the original plant active set value of the hydropower plant, and get the difference ΔP of the two;
S3120) calculate the regulation amount Δpᵢ of secondary frequency modulation distributed to the unit i:
S3121) if ΔP is greater than 0, Δpᵢ is equal to ΔP divided by the number of units that are under AGC control, in generating state, and the single active power set value is less than the upper limit of the active operation interval;
S3122) if ΔP is less than 0, Δpᵢ is equal to ΔP divided by the number of units that are under AGC control, in generating state, and the single active power set value is greater than the lower limit of the active operation interval;
S3130) calculate the single active power set value pᵢ^{set} set of each unit:
S3131) if the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S3132) if the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit);
S3140) sum the single active power set values of all units to obtain the updated original plant active power set value of the hydropower plant;
S3150) based on the updated original plant active power set value of the hydropower plant, recalculate ΔP by the method in S3110;
S3151) if ΔP is not equal to 0, go to step S3120 to perform the distribution calculation of the regulation amount of secondary frequency modulation again;
S3152) if ΔP is equal to 0, end the distribution calculation of the regulation amount of secondary frequency, and obtain the single active power set value pⁱₛₑₜ of each hydropower generating unit;
S3200) send the single active power set value pᵢ^{set} of each hydropower generating unit to an AGC control system of each hydropower generating unit;
S3300) each unit performs open-loop gain regulation according to the received single active power set value pᵢ^{set}:
S3320) set the gain regulation mark α of secondary frequency modulation to 1 or 0, and each unit obtains α and adjusts the output pulse length of open-loop regulation according to the calculated gain:
S3321) if α is equal to 1 and pᵢ^{set} is greater than pᵢ, calculate the increased active power relay pulse length tᵤ, where tᵤ=γ+(pᵢ^{set}−pᵢ)×k₂;
S3322) if α is equal to 1 and pᵢ^{set} is less than pᵢ, calculate the decreased active power relay pulse length t_{d}, where t_{d}=γ+(pᵢ−pᵢ^{set})×k₂;
S3323) if α is equal to 0, perform the conventional single active power closed-loop regulation instead of open-loop gain regulation;
wherein, pᵢ is the single active power actual value of the unit i, k₂ is the manually set ratio parameter, γ is the minimum effective pulse length of the equipment;
S3330) control the output relay operation of the unit according to the pulse length:
S3331) when tᵤ is greater than 0, trigger the increased active power relay operation;
S3332) when t_{d} is greater than 0, trigger the decreased active power relay operation;
S3340) correct the output pulse length of the open-loop gain regulation in each AGC system operation cycle:
S3341) when tᵤ is greater than 0, tᵤ=max(tᵤ−t_{s,} 0), where tₛ is the operation cycle time of the AGC system;
S3342) when t_{d} is greater than 0, td=max(td−ts, 0);
S3343) if tᵤ is greater than 0 and pᵢ≥pᵢ^{set}+pᵢ^{dead}, tu=0, where pᵢ^{dead} is the single active power regulation dead zone of the unit i;
S3344) if t_{d} is greater than 0 and pᵢ<pᵢ^{set}−pᵢ^{dead}, td=0;
S3350) Judge the output pulse length of the open-loop gain regulation in each operation cycle of the AGC system:
S3351) if tᵤ is less than 0 or t_{d} is greater than 0, go to step S3330 and continue to execute S3330, S3340 and S3350;
S3352) if tᵤ is equal to 0 and t_{d} is equal to 0, end the open-loop gain regulation; at the same time, set the secondary frequency modulation gain regulation mark α of the unit in the hydropower plant to 0;
S3400) judge whether the single active power actual value pᵢ of each unit is within the regulation dead zone range of the single active power set value pᵢ^{set}:
S3410) if pᵢ≥pᵢ^{set}+pᵢ^{dead} or pᵢ<pᵢ^{set}−pᵢ^{dead}, continue the single active power closed-loop regulation;
S3420) if pᵢ^{set}+pᵢ^{dead}≥pᵢ≥pᵢ^{set}−pᵢ^{dead,}end the single active power closed-loop regulation.

5. The secondary frequency modulation method for the hydropower plant which satisfies positive correlation between the regulation rate and the rated capacity of the hydropower plant according to claim 3, characterized in that the feedforward gain regulation includes the following operating steps:
S3100) calculate the single active power set value of each hydropower generating unit pᵢ^{set};
S3110) subtract the plant active power set value of the secondary frequency modulation command from the original plant active set value of the hydropower plant, and get the difference ΔP of the two;
S3120) calculate the regulation amount Δpᵢ of secondary frequency modulation distributed to the unit i:
S3121) if ΔP is greater than 0, Δpᵢ is equal to ΔP divided by the number of units that are under AGC control, in generating state, and the single active power set value is less than the upper limit of the active operation interval;
S3122) if ΔP is less than 0, Δpᵢ is equal to ΔP divided by the number of units that are under AGC control, in generating state, and the single active power set value is greater than the lower limit of the active operation interval;
S3130) calculate the single active power set value pᵢ^{set} of each unit:
S3131) if the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S3132) if the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit);
S3140) sum the single active power set values of all units to obtain the updated original plant active power set value of the hydropower plant;
S3150) based on the updated original plant active power set value of the hydropower plant, recalculate ΔP by the method in S3110;
S3151) if ΔP is not equal to 0, go to step S3120 to perform the distribution calculation of the regulation amount of secondary frequency modulation again;
S3152) if ΔP is equal to 0, end the distribution calculation of the regulation amount of secondary frequency, and obtain the single active power set value pᵢ^{set} of each hydropower generating unit;
S3200) send the single active power set value pᵢ^{set} of each hydropower generating unit to an AGC control system of each hydropower generating unit;
S3300) each unit performs open-loop gain regulation according to the received single active power set value pᵢ^{set}:
S3320) set the gain regulation mark α of secondary frequency modulation to 1 or 0, and each unit obtains α and adjusts the output pulse length of open-loop regulation according to the calculated gain:
S3321) if α is equal to 1 and pᵢ^{set} is greater than pᵢ, calculate the increased active power relay pulse length tᵤ, where tᵤ=γ+(pᵢ^{set}−pᵢ)×k₂;
S3322) if α is equal to 1 and pᵢ^{set} is less than pᵢ, calculate the decreased active power relay pulse length t_{d}, where t_{d}=γ+(pᵢ−pᵢ^{set})×k₂;
S3323) if α is equal to 0, perform the conventional single active power closed-loop regulation instead of open-loop gain regulation;
wherein, pᵢ is the single active power actual value of the unit i, k₂ is the manually set ratio parameter, γ is the minimum effective pulse length of the equipment;
S3330) control the output relay operation of the unit according to the pulse length:
S3331) when tᵤ is greater than 0, trigger the increased active power relay operation;
S3332) when t_{d} is greater than 0, trigger the decreased active power relay operation;
S3340) correct the output pulse length of the open-loop gain regulation in each AGC system operation cycle:
S3341) when tᵤ is greater than 0, tᵤ=max(tᵤ−tₛ, 0), where tₛ is the operation cycle time of the AGC system;
S3342) when t_{d} is greater than 0, td=max(td−ts, 0);
S3343) if tᵤ is greater than 0 and pᵢ≥pᵢ^{set}+pᵢ^{dead}, tu=0, where pᵢ^{dead} is the single active power regulation dead zone of the unit i;
S3344) if t_{d} is greater than 0 and pᵢ<pᵢ^{set}−pᵢ^{dead}, td=0;
S3350) judge the output pulse length of the open-loop gain regulation in each operation cycle of the AGC system:
S3351) if tᵤ is less than 0 or t_{d} is greater than 0, go to step S3330 and continue to execute S3330, S3340 and S3350;
S3352) if tᵤ is equal to 0 and t_{d} is equal to 0, end the open-loop gain regulation; at the same time, set the secondary frequency modulation gain regulation mark α of the unit in the hydropower plant to 0;
S3400) judge whether the single active power actual value pᵢ of each unit is within the regulation dead zone range of the single active power set value pᵢ^{set}:
S3410) if pᵢ≥pᵢ^{set}+pᵢ^{dead} or pᵢ<pᵢ^{set}−pᵢ^{dead}, continue the single active power closed-loop regulation;
S3420) if pᵢ^{set}+pᵢ^{dead}≥pᵢ≥pᵢ^{set}−pᵢ^{dead}, end the single active power closed-loop regulation.

6. The secondary frequency modulation method for the hydropower plant which satisfies positive correlation between the regulation rate and the rated capacity of the hydropower plant according to claim 2, characterized in that the amplification gain regulation is to equally distribute the difference between the plant active power set value of the secondary frequency modulation command and the original plant active power set value of the hydropower plant to each hydropower generating unit participating in the secondary frequency modulation to obtain the regulation amount of secondary frequency modulation; then obtain the single active power set value of each unit according to the original single active power set value and distribute the single active power set value to each unit;
within the gain regulation time threshold shorter than the time interval threshold T, each unit enlarges and updates the regulation amount of the single active power set value based on the single active power assigned value in the same direction, and the enlarged amount is the single active power regulation dead zone multiplied by the set ratio parameter;
each unit performs the single active power closed-loop regulation according to the updated single active power set value; when the amplification gain regulation time reaches the gain regulation time threshold, the current single active power set value is set to the single active power assigned value.

7. The secondary frequency modulation method for the hydropower plant which satisfies positive correlation between the regulation rate and the rated capacity of the hydropower plant according to claim 2, characterized in that the amplification gain regulation includes the following operating steps:
S4100) calculate the active power assigned value pᵢ^{AGC} of each hydropower generating unit;
S4110) subtract the plant active power set value of the secondary frequency modulation command from the original plant active set value of the hydropower plant, and get the difference ΔP of the two;
S4120) calculate the regulation amount Δpᵢ of secondary frequency modulation distributed to the unit i:
S4121) if ΔP is greater than 0, Δpᵢ is equal to ΔP divided by the number of units that are under AGC control, in generating state, and the single active power set value is less than the upper limit of the active operation interval;
S4122) if ΔP is less than 0, Δpᵢ is equal to ΔP divided by the number of units that are under AGC control, in generating state, and the single active power set value is greater than the lower limit of the active operation interval;
S4130) calculate the single active power assigned value pᵢ^{AGC} of each unit:
S4131) if the single regulation amount Δpᵢ of secondary frequency modulation of the unit i is greater than 0, the single active power assigned value pᵢ^{AGC} is equal to min (the original single active power assigned value+the single regulation amount Δpᵢ of secondary frequency modulation, the upper limit of the active operation interval of the unit);
S4132) if the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit);
S4140) sum the single active power assigned values of all units to obtain an updated original active power set value of the hydropower plant;
S4150) based on the updated original plant active power set value of the hydropower plant, recalculate ΔP;
S4151) if ΔP is not equal to 0, go to step S4120 to carry out the distribution calculation of the regulation amount of secondary frequency modulation again;
S4152) if ΔP is equal to 0, end the distribution calculation of the regulation amount of secondary frequency modulation, and obtain the single active power assigned value pᵢ^{AGC} of each hydropower generating unit;
S4200) send the single active power assigned value pᵢ^{AGC} of each hydropower generating unit to an AGC control system of each hydropower generating unit;
S4310) set the gain regulation time threshold T₁ less than the time interval threshold T;
if the judgment conditions for the secondary frequency modulation gain regulation are met, the hydropower plant sets the secondary frequency modulation gain regulation mark α to 1; otherwise, the hydropower plant sets the secondary frequency modulation gain regulation mark α to 0; the hydropower plant sends the secondary frequency modulation gain regulation mark to each hydropower generating unit;
S4320) set a timer C2 to time the amplification gain regulation time:
S4321) if α is equal to 1, start the timer C2 for timing;
S4322) if α is equal to 0, stop and reset the timer C2;
S4330) each unit updates the active power set value pᵢ^{set} according to the secondary frequency modulation gain regulation mark α and the received single active power assigned value pᵢ^{AGC};
S4331) if α is equal to 1 and pᵢ^{AGC} is greater than the current pᵢ^{set}, update pᵢ^{set} to pᵢ^{set}=pᵢ^{AGC}+k₃×pᵢ^{dead};
S4331) if α is equal to 1 and pᵢ^{AGC} is greater than the current pᵢ^{set}, update pᵢ^{set} to pᵢ^{set}=pᵢ^{AGC}+k₃×pᵢ^{dead};
S4332) if α is equal to 1 and pᵢ^{AGC} is less than the current pᵢ^{set}, update pᵢ^{set} to pᵢ^{set}=pᵢ^{AGC}−k₃×pᵢ^{dead};
where pᵢ^{dead} is the single active power regulation dead zone of the unit i, and k₃ is the manually set ratio parameter greater than or equal to 1;
S4333) if α is equal to 0, set pᵢ^{set} to pᵢ^{set}=pᵢ^{AGC};
each unit performs single active power closed-loop regulation according to the updated single active power set value pᵢ^{set};
S4340) take the time t₂ of the timer C2 in each operation cycle of the AGC system;
when t₂ is greater than or equal to the gain regulation time threshold T₁, update pᵢ^{set} to pᵢ^{set}=pᵢ^{AGC}, stop the timing of the timer C2, and reset the timer C2; set the secondary frequency modulation gain regulation mark α to 0;
each unit performs single active power closed-loop regulation according to the updated single active power set value pᵢ^{set}.

8. The secondary frequency modulation method for the hydropower plant which satisfies positive correlation between the regulation rate and the rated capacity of the hydropower plant according to claim 6, characterized in that the amplification gain regulation includes the following operating steps:
S4100) calculate the active power assigned value pᵢ^{AGC} of each hydropower generating unit;
S4110) subtract the plant active power set value of the secondary frequency modulation command from the original plant active set value of the hydropower plant, and get the difference ΔP of the two;
S4120) calculate the regulation amount Δpᵢ of secondary frequency modulation distributed to the unit i:
S4121) if ΔP is greater than 0, Δpᵢ is equal to ΔP divided by the number of units that are under AGC control, in generating state, and the single active power set value is less than the upper limit of the active operation interval;
S4122) if ΔP is less than 0, Δpᵢ is equal to ΔP divided by the number of units that are under AGC control, in generating state, and the single active power set value is greater than the lower limit of the active operation interval;
S4130) calculate the single active power assigned value pᵢ^{AGC} of each unit:
S4131) if the single regulation amount Δpᵢ of secondary frequency modulation of the unit i is greater than 0, the single active power assigned value pᵢ^{AGC} is equal to min (the original single active power assigned value+the single regulation amount Δpᵢ of secondary frequency modulation, the upper limit of the active operation interval of the unit);
S4132) if the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit);
S4140) sum the single active power assigned values of all units to obtain an updated original active power set value of the hydropower plant;
S4150) based on the updated original plant active power set value of the hydropower plant, recalculate ΔP;
S4151) if ΔP is not equal to 0, go to step S4120 to carry out the distribution calculation of the regulation amount of secondary frequency modulation again;
S4152) if ΔP is equal to 0, end the distribution calculation of the regulation amount of secondary frequency modulation, and obtain the single active power assigned value pᵢ^{AGC} of each hydropower generating unit;
S4200) send the single active power assigned value pᵢ^{AGC} of each hydropower generating unit to an AGC control system of each hydropower generating unit;
S4310) set the gain regulation time threshold T₁ less than the time interval threshold T;
if the judgment conditions for the secondary frequency modulation gain regulation are met, the hydropower plant sets the secondary frequency modulation gain regulation mark α to 1; otherwise, the hydropower plant sets the secondary frequency modulation gain regulation mark α to 0; the hydropower plant sends the secondary frequency modulation gain regulation mark to each hydropower generating unit;
S4320) set a timer C2 to time the amplification gain regulation time:
S4321) if α is equal to 1, start the timer C2 for timing;
S4322) if α is equal to 0, stop and reset the timer C2;
S4330) each unit updates the active power set value pᵢ^{set} according to the secondary frequency modulation gain regulation mark α and the received single active power assigned value pᵢ^{AGC};
S4331) if α is equal to 1 and pᵢ^{AGC} is greater than the current pᵢ^{set}, update pᵢ^{set} to pᵢ^{set}=pᵢ^{AGC}+k₃×pᵢ^{dead};
S4331) if α is equal to 1 and pᵢ^{AGC} is greater than the current pᵢ^{set}, update pᵢ^{set} to pᵢ^{set}=pᵢ^{AGC}+k₃×pᵢ^{dead};
S4332) if α is equal to 1 and pᵢ^{AGC} is less than the current pᵢ^{set}, update pᵢ^{set}=pᵢ^{AGC}−k₃×pᵢ^{dead};
where pᵢ^{dead} is the single active power regulation dead zone of the unit i, and k₃ is the manually set ratio parameter greater than or equal to 1;
S4333) if α is equal to 0, set pᵢ^{set} to pᵢ^{set}=pᵢ^{AGC};
each unit performs single active power closed-loop regulation according to the updated single active power set value pᵢ^{set};
S4340) take the time t₂ of the timer C2 in each operation cycle of the AGC system;
when t₂ is greater than or equal to the gain regulation time threshold T₁, update pᵢ^{set} to pᵢ^{set}=pᵢ^{AGC}, stop the timing of the timer C2, and reset the timer C2; set the secondary frequency modulation gain regulation mark α to 0;
each unit performs single active power closed-loop regulation according to the updated single active power set value pᵢ^{set}.

9. The secondary frequency modulation method for the hydropower plant which satisfies positive correlation between the regulation rate and the rated capacity of the hydropower plant according to claim 2, characterized in that the transfer gain regulation is to divide operating AGC hydropower generating units into units participating in secondary frequency modulation and units not participating in secondary frequency modulation, and transfer the regulation margin of the units not participating in secondary frequency modulation to the units participating in secondary frequency modulation by adjusting the single active power set value of the units not participating in secondary frequency modulation, and the transferred regulation margin of a single unit is related to the single active power regulation dead zone multiplied by the ratio parameter;
on the premise that the plant active power set value of the hydropower plant meets the plant active set value of the secondary frequency modulation command, the hydropower generating units participating the secondary frequency modulation obtain the regulation amount of secondary frequency modulation including the transferred regulation margin, and distribute the regulation amount of secondary frequency modulation equally to each hydropower generating units participating the secondary frequency modulation by setting the single active set value;
the single active power set value of each hydropower generating unit is sent to each hydropower generating unit for closed-loop regulation.

10. The secondary frequency modulation method for the hydropower plant which satisfies positive correlation between the regulation rate and the rated capacity of the hydropower plant according to claim 2, characterized in that the transfer gain regulation includes the following operating steps:
S5100) subtract the plant active power set value of the secondary frequency modulation command from the original plant active set value of the hydropower plant, and get the difference ΔP of the two;
S5200) calculate the number m of hydropower generating units participating in the secondary frequency modulation, m approximates |ΔP| divided by the capacity β of segmented unit, where the capacity β of segmented unit is a manually set parameter, and m values as the natural number obtained by dividing the absolute value closest to ΔP by the capacity β of segmented unit;
S5300) select hydropower generating units participating in the secondary frequency modulation:
S5310) judge ΔP:
S5311) if ΔP is greater than 0, calculate the absolute difference between the single active power actual value and the upper limit of the active operation interval for all units having AGC put into operation;
S5312) if ΔP is less than 0, calculate the absolute difference between the single active power actual value and the lower limit of the active operation interval for all units having AGC put into operation;
S5320) sort all units having AGC put into operation from largest to smallest according to the results obtained in S5310;
S5330) select the first m units from the units having AGC put into operation according to the sorting result in S5320 as the hydropower generating units participating in the secondary frequency modulation; take the remaining units as the hydropower generating units not participating in the secondary frequency modulation;
if the judgment conditions for the secondary frequency modulation gain regulation are met, set the secondary frequency modulation gain regulation mark α to 1; otherwise, set the secondary frequency modulation gain regulation mark α to 0;
S5400) correct the single active set value pᵢ^{set} of the units having AGC put into operation but not participating in the secondary frequency modulation according to the secondary frequency modulation gain regulation mark α and the difference ΔP between the plant active power set value of the secondary frequency modulation command and the original active set value of the hydropower plant:
S5410) if α is equal to 1 and ΔP is greater than 0, correct the single active power set value pᵢ^{set} of the units not participating in the secondary frequency modulation to pᵢ^{set}=max(pᵢ−pᵢ^{dead}×k₄, pᵢ), where pᵢ is the single active power actual value of the unit i, pᵢ^{dead} is the single active power regulation dead zone of the unit i, k₄ is the manually set ratio parameter less than 1 and greater than 0, and pᵢ is the lower limit of the current active operation interval of the unit i;
S5420) if α is equal to 1 and ΔP is less than 0, correct the single active power set value pᵢ^{set} of the units not participating in the secondary frequency modulation to pᵢ^{set}=min(pᵢ+pᵢ^{dead}×k₄, p̅ᵢ̅), where p̅ᵢ̅ is the upper limit of the current active operation interval of the unit i;
S5430) if α is equal to 0, correct the single active power set value pᵢ^{set} of the units not
participating in the secondary frequency modulation to pᵢ^{set}=pᵢ;
S5500) correct the single active power set value pᵢ^{set} of the units having AGC put into operation and participating in the secondary frequency modulation:
S5510) sum the single active power set values of all units to obtain the updated original plant active power set value of the hydropower plant;
S5520) based on the updated original plant active power set value of the hydropower plant, recalculate ΔP;
S5530) calculate the regulation amount Δpᵢ of secondary frequency modulation distributed to the unit i having AGC put into operation and participating in the secondary frequency modulation:
S5531) if ΔP is greater than 0, Δpᵢ is equal to ΔP divided by the number of units under AGC control, participating in the secondary frequency modulation, and with the single active power set value less than the upper limit of the active operation interval;
S5532) if ΔP is less than 0, Δpᵢ is equal to ΔP divided by the number of units under AGC control, participating in the secondary frequency modulation, and with the single active power set value less than the lower limit of the active operation interval;
S5540) calculate the single active power set value pᵢ^{set} of the units having AGC put into operation and participating in the secondary frequency modulation:
S5541) if the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S5542) if the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit);
S5550) sum the single active power set values of all units to obtain the updated original plant active power set value of the hydropower plant;
S5560) based on the updated original plant active power set value of the hydropower plant, recalculate ΔP;
S5561) if ΔP is greater than 0, and the active power set value pᵢ^{set} of a single unit having AGC put into operation and participating in the secondary frequency modulation is less than the upper limit of the active power operation interval, go to step S5530 to carry out the distribution calculation of the regulation amount of secondary frequency modulation again;
S5562) if ΔP is less than 0, and the active power set value pᵢ^{set} of a single unit having AGC put into operation and participating in the secondary frequency modulation is greater than the lower limit of the active power operation interval, go to step S5530 to carry out the distribution calculation of the regulation amount of secondary frequency modulation again;
S5563) if ΔP is greater than 0, and the active power set value pᵢ^{set} of all single units having AGC put into operation and participating in the secondary frequency modulation is greater than or equal to the upper limit of the active power operation interval, go to step S5600, and calculate the secondary frequency modulation Δpᵢ of the single units distributed to each operating AGC but not participating in the secondary frequency modulation to correct the transfer amount;
S5564) if ΔP is less than 0, and the active power set value pᵢ^{set} of all single units having AGC put into operation and participating in the secondary frequency modulation is less than or equal to the lower limit of the active power operation interval, go to step S5600, and calculate the secondary frequency modulation Δpᵢ of the single units distributed to each operating AGC but not participating in the secondary frequency modulation to correct the transfer amount;
S5565) if ΔP is equal to 0, end the distribution calculation of secondary frequency modulation, and obtain the single active power set value pᵢ^{set} of each hydropower generating unit having AGC put into operation and participating in the secondary frequency modulation unit;
S5600) correct the single active set value pᵢ^{set} of the units having AGC put into operation but not participating in the secondary frequency modulation again:
S5610) sum the single active power set values of all units to obtain the updated original plant active power set value of the hydropower plant;
S5620) calculate the difference ΔP between the updated original active power set value and the active power set value of the second frequency modulation command of the hydropower plant, where ΔP is equal to the plant active power set value of the second frequency modulation command minus the plant active power set value obtained in S5610;
S5630) calculate the regulation amount of secondary frequency modulation Δpᵢ distributed to each unit i having AGC put into operation but not participating in the secondary frequency modulation:
S5631) if ΔP is greater than 0, Δpᵢ is equal to ΔP divided by the number of units under AGC control, not participating in the secondary frequency modulation, and with the single active power set value less than the upper limit of the active operation interval;
S5632) if ΔP is less than 0, Δpᵢ is equal to ΔP divided by the number of units under AGC control, not participating in the secondary frequency modulation, and with the single active power set value greater than the lower limit of the active operation interval;
S5640) calculate the single active set value pᵢ^{set} of the units having AGC put into operation but not participating in the secondary frequency modulation:
S5641) if the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S5642) if the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit);
S5650) sum the single active power set values of all units to obtain the updated original plant active power set value of the hydropower plant;
S5660) based on the updated original plant active power set value of the hydropower plant, recalculate ΔP by the method in S5620:
S5661) if ΔP is greater than 0, go to step S5630 to carry out the distribution calculation of the regulation amount of secondary frequency modulation again;
S5662) if ΔP is less than 0, go to step S5630 to carry out the distribution calculation of the regulation amount of secondary frequency modulation again;
S5663) if ΔP is equal to 0, end the distribution calculation of secondary frequency modulation, and obtain the single active power set value pᵢ^{set} of each hydropower generating unit having AGC put into operation but not participating in the secondary frequency modulation unit;
then, send the single active power set value pᵢ^{set} of each hydropower generating unit to the AGC system of each hydropower generating unit for closed-loop regulation, and set the secondary frequency modulation gain regulation mark α to 0.

11. The secondary frequency modulation method for the hydropower plant which satisfies positive correlation between the regulation rate and the rated capacity of the hydropower plant according to claim 9, characterized in that the transfer gain regulation includes the following operating steps:
S5100) subtract the plant active power set value of the secondary frequency modulation command from the original plant active set value of the hydropower plant, and get the difference ΔP of the two;
S5200) calculate the number m of hydropower generating units participating in the secondary frequency modulation, m approximates |ΔP| divided by the capacity β of segmented unit, where the capacity β of segmented unit is a manually set parameter, and m values as the natural number obtained by dividing the absolute value closest to ΔP by the capacity β of segmented unit;
S5300) select hydropower generating units participating in the secondary frequency modulation:
S5310) judge ΔP:
S5311) if ΔP is greater than 0, calculate the absolute difference between the single active power actual value and the upper limit of the active operation interval for all units having AGC put into operation;
S5312) if ΔP is less than 0, calculate the absolute difference between the single active power actual value and the lower limit of the active operation interval for all units having AGC put into operation;
S5320) sort all units having AGC put into operation from largest to smallest according to the results obtained in S5310;
S5330) select the first m units from the units having AGC put into operation according to the sorting result in S5320 as the hydropower generating units participating in the secondary frequency modulation; take the remaining units as the hydropower generating units not participating in the secondary frequency modulation;
If the judgment conditions for the secondary frequency modulation gain regulation are met, set the secondary frequency modulation gain regulation mark α to 1; otherwise, set the secondary frequency modulation gain regulation mark α to 0;
S5400) correct the single active set value pᵢ^{set} of the units having AGC put into operation but not participating in the secondary frequency modulation according to the secondary frequency modulation gain regulation mark a and the difference ΔP between the plant active power set value of the secondary frequency modulation command and the original active set value of the hydropower plant:
S5410) if α is equal to 1 and ΔP is greater than 0, correct the single active power set value pᵢ^{set} of the units not participating in the secondary frequency modulation to pᵢ^{set}=max(pᵢ−pᵢ^{dead}×k₄, pᵢ), where pᵢ is the single active power actual value of the unit i, pᵢ^{dead} is the single active power regulation dead zone of the unit i, k₄ is the manually set ratio parameter less than 1 and greater than 0, and pᵢ is the lower limit of the current active operation interval of the unit i;
S5420) if α is equal to 1 and ΔP is less than 0, correct the single active power set value pᵢ^{set} of the units not participating in the secondary frequency modulation to pᵢ^{set}=min(pᵢ+pᵢ^{dead}×k₄, p̅ᵢ̅), where p̅ᵢ̅ is the upper limit of the current active operation interval of the unit i;
S5430) if α is equal to 0, correct the single active power set value pᵢ^{set} of the units not participating in the secondary frequency modulation to pᵢ^{set}=pᵢ;
S5500) correct the single active power set value pᵢ^{set} of the units having AGC put into operation and participating in the secondary frequency modulation:
S5510) sum the single active power set values of all units to obtain the updated original plant active power set value of the hydropower plant;
S5520) based on the updated original plant active power set value of the hydropower plant, recalculate ΔP;
S5530) calculate the regulation amount Δpᵢ of secondary frequency modulation distributed to the unit i having AGC put into operation and participating in the secondary frequency modulation:
S5531) if ΔP is greater than 0, Δpᵢ is equal to ΔP divided by the number of units under AGC control, participating in the secondary frequency modulation, and with the single active power set value less than the upper limit of the active operation interval;
S5532) if ΔP is less than 0, Δpᵢ is equal to ΔP divided by the number of units under AGC control, participating in the secondary frequency modulation, and with the single active power set value less than the lower limit of the active operation interval;
S5540) calculate the single active power set value pᵢ^{set} of the units having AGC put into operation and participating in the secondary frequency modulation:
S5541) if the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S5542) if the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit);
S5550) sum the single active power set values of all units to obtain the updated original plant active power set value of the hydropower plant;
S5560) based on the updated original plant active power set value of the hydropower plant, recalculate ΔP;
S5561) if ΔP is greater than 0, and the active power set value pᵢ^{set} of a single unit having AGC put into operation and participating in the secondary frequency modulation is less than the upper limit of the active power operation interval, go to step S5530 to carry out the distribution calculation of the regulation amount of secondary frequency modulation again;
S5562) if ΔP is less than 0, and the active power set value pᵢ^{set} of a single unit having AGC put into operation and participating in the secondary frequency modulation is greater than the lower limit of the active power operation interval, go to step S5530 to carry out the distribution calculation of the regulation amount of secondary frequency modulation again;
S5563) if ΔP is greater than 0, and the active power set value pᵢ^{set} of all single units having AGC put into operation and participating in the secondary frequency modulation is greater than or equal to the upper limit of the active power operation interval, go to step S5600, and calculate the secondary frequency modulation Δpᵢ of the single units distributed to each operating AGC but not participating in the secondary frequency modulation to correct the transfer amount;
S5564) if ΔP is less than 0, and the active power set value pᵢ^{set} of all single units having AGC put into operation and participating in the secondary frequency modulation is less than or equal to the lower limit of the active power operation interval, go to step S5600, and calculate the secondary frequency modulation Δpᵢ of the single units distributed to each operating AGC but not participating in the secondary frequency modulation to correct the transfer amount;
S5565) if ΔP is equal to 0, end the distribution calculation of secondary frequency modulation, and obtain the single active power set value pᵢ^{set} of each hydropower generating unit having AGC put into operation and participating in the secondary frequency modulation unit;
S5600) correct the single active set value pᵢ^{set} of the units having AGC put into operation but not participating in the secondary frequency modulation again:
S5610) sum the single active power set values of all units to obtain the updated original plant active power set value of the hydropower plant;
S5620) calculate the difference ΔP between the updated original active power set value and the active power set value of the second frequency modulation command of the hydropower plant, where ΔP is equal to the plant active power set value of the second frequency modulation command minus the plant active power set value obtained in S5610;
S5630) calculate the regulation amount of secondary frequency modulation Δpᵢ distributed to each unit i having AGC put into operation but not participating in the secondary frequency modulation:
S5631) if ΔP is greater than 0, Δpᵢ is equal to ΔP divided by the number of units under AGC control, not participating in the secondary frequency modulation, and with the single active power set value less than the upper limit of the active operation interval;
S5632) if ΔP is less than 0, Δpᵢ is equal to ΔP divided by the number of units under AGC control, not participating in the secondary frequency modulation, and with the single active power set value greater than the lower limit of the active operation interval;
S5640) calculate the single active set value pᵢ^{set} of the units having AGC put into operation but not participating in the secondary frequency modulation:
S5641) if the regulation amount Δpᵢ of secondary frequency modulation of the unit i is greater than 0, the single active power set value pᵢ^{set} is equal to min (the original single active power set value of the unit+the regulation amount Δpᵢ of secondary frequency modulation of the unit, the upper limit of the active operation interval of the unit);
S5642) if the regulation amount Δpᵢ of secondary frequency modulation of the unit i is less than 0, the single active power set value pᵢ^{set} is equal to max (the original single active power set value of the unit+the regulation amount Δpᵢ of secondary frequency modulation of the unit, the lower limit of the active operation interval of the unit);
S5650) sum the single active power set values of all units to obtain the updated original plant active power set value of the hydropower plant;
S5660) based on the updated original plant active power set value of the hydropower plant, recalculate ΔP by the method in S5620:
S5661) if ΔP is greater than 0, go to step S5630 to carry out the distribution calculation of the regulation amount of secondary frequency modulation again;
S5662) if ΔP is less than 0, go to step S5630 to carry out the distribution calculation of the regulation amount of secondary frequency modulation again;
S5663) if ΔP is equal to 0, end the distribution calculation of secondary frequency modulation, and obtain the single active power set value pᵢ^{set} of each hydropower generating unit having AGC put into operation but not participating in the secondary frequency modulation unit;
then, send the single active power set value pᵢ^{set} of each hydropower generating unit to the AGC system of each hydropower generating unit for closed-loop regulation, and set the secondary frequency modulation gain regulation mark α to 0.

12. The secondary frequency modulation method for the hydropower plant which satisfies positive correlation between the regulation rate and the rated capacity of the hydropower plant according to claim 1, characterized in that when the regulation time of secondary frequency modulation of the hydropower plant reaches the calibration time threshold and the number of hydropower generating units with single active power regulation uncompleted is not more than one after the gain regulation, if the error ratio of secondary frequency modulation is greater than the calibration accuracy threshold, carryout the following calibration regulation of secondary frequency modulation:
select the units with single active power regulation uncompleted or the units with the maximum absolute difference between the single active power set value and the single active power actual value as the units performing the calibration regulation;
obtain the single active power pre-assigned value of the units performing calibration regulation by the plant active power set value minus the single active power actual value of all units not performing calibration regulation;
if the obtained active power pre-assigned value of a single unit is greater than or equal to the lower limit of the active operation interval of the unit, and less than or equal to the upper limit of the active operation interval of the unit, set the single active power set value of the unit performing calibration regulation to the single active power pre-assigned value and carry out calibration regulation; otherwise, no calibration regulation is performed.

13. The secondary frequency modulation method for the hydropower plant which satisfies positive correlation between the regulation rate and the rated capacity of the hydropower plant according to claim 2, characterized in that when the regulation time of secondary frequency modulation of the hydropower plant reaches the calibration time threshold and the number of hydropower generating units with single active power regulation uncompleted is not more than one after the gain regulation, if the error ratio of secondary frequency modulation is greater than the calibration accuracy threshold, carryout the following calibration regulation of secondary frequency modulation:
select the units with single active power regulation uncompleted or the units with the maximum absolute difference between the single active power set value and the single active power actual value as the units performing the calibration regulation;
obtain the single active power pre-assigned value of the units performing calibration regulation by the plant active power set value minus the single active power actual value of all units not performing calibration regulation;
if the obtained active power pre-assigned value of a single unit is greater than or equal to the lower limit of the active operation interval of the unit, and less than or equal to the upper limit of the active operation interval of the unit, set the single active power set value of the unit performing calibration regulation to the single active power pre-assigned value and carry out calibration regulation; otherwise, no calibration regulation is performed.

14. The secondary frequency modulation method for the hydropower plant which satisfies positive correlation between the regulation rate and the rated capacity of the hydropower plant according to claim 12, characterized in that the calibration regulation of secondary frequency modulation includes the following operating steps:
S6110) set the calibration regulation time threshold, which is equal to the time required from receiving the secondary frequency modulation command from the hydropower plant to completing the single active power closed-loop regulation for each hydropower generating unit for the first time;
S6120) set the timer, and start the timing after receiving the secondary frequency modulation command;
S6130) read the time interval of the timer, and adjust the time to reach the calibration time threshold if greater than or equal to the calibration time threshold;
S6210) set the fluctuation judgment threshold for the completion of single active power regulation, which is equal to a periodic variation of the single active power actual value caused by random fluctuation after each hydropower generating unit completes single active power regulation;
S6220) set an array [Δp₁¹, Δp₁² . . . Δpᵢⁿ] containing n elements for each unit, where n is the manually set parameter;
S6230) calculate Δp₁¹ in each AGC system cycle, where Δp₁¹ is equal to the absolute difference between the single active power actual value collected by the unit i in the cycle and the single active power actual value collected in the previous cycle;
S6240) assign values to all elements of the array in each AGC system cycle in turn, so that Δpᵢⁿ=Δᵢⁿ⁻¹, and Δpᵢⁿ⁻¹=Δᵢⁿ⁻² . . . Δpᵢ²=Δᵢ¹;
S6250) after n AGC system cycles, judge whether the single active power of each unit is regulated:
S6251) calculate the weighted average of the array elements for the unit i,
$$\frac{{\sum }_{i = 1}^{n} Δ {p}_{i}^{j} \times ( n + 1 - j )}{{\sum }_{i = 1}^{n} n + 1 - j} ,$$
where Δpᵢ^{j} is the j^{th} element in the array of the unit i;
S6252) if the fluctuation weighted average of the unit i obtained in S6251 is less than the fluctuation judgment threshold, the single active power regulation of the unit i is completed;
S6253) if the fluctuation weighted average of the unit i obtained in S6251 is greater than the fluctuation judgment threshold, the single active power regulation of the unit i is not completed;
S6260) if the number of units with single active power regulation not completed is more than one, the secondary frequency modulation of the hydropower plant is not completed;
S6270) if the number of units with single active power regulation not completed is not more than one, the secondary frequency modulation of the hydropower plant is basically completed;
S6310) set the calibration regulation accuracy threshold to 1.5-0.5%;
S6320) obtain the absolute difference between the plant active power set value and the plant active power actual value;
S6330) obtain the sum of the rated powers of all units in generating state;
S6340) the error ratio of secondary frequency modulation is equal to the absolute difference obtained in S6320 divided by the sum of the rated powers obtained in S6330;
S6350) compare the error ratio of secondary frequency modulation with the calibration accuracy threshold:
S6351) if the error ratio is greater than the accuracy threshold, perform the calibration regulation of secondary frequency modulation;
S6352) if the error ratio is less than the accuracy threshold, end the calibration regulation of secondary frequency modulation;
S6400) if one unit fails to complete the single active power regulation, select the unit to perform the calibration regulation;
if all units complete the single active power regulation, calculate the absolute difference between the single active power set value and the single active power actual value of the units having AGC put into operation, and select the unit with the maximum absolute difference to perform the calibration regulation;
S6500) compare the single active power pre-assigned value of the unit performing calibration regulation with the upper and lower limits of the active operation interval:
S6510) if the single active power pre-assigned value of the unit performing calibration regulation is greater than or equal to the lower limit of the active operation interval of the unit, and less than or equal to the upper limit of the active operation interval of the unit:
S6511) set the single active power set value pᵢ^{set} of the unit performing calibration regulation to the single active power pre-assigned value;
S6512) set the single active power set value pⁱₛₑₜ of the unit not performing calibration regulation to the single active power actual value, namely, pᵢ^{set}=pᵢ; pᵢ is the single active power actual value of the unit i;
S6513) send the single active power set value pᵢ^{set} of each hydropower generating unit to a control system of each hydropower generating unit for single active power closed-loop regulation;
S6520) if the single active power pre-assigned value of the unit performing calibration regulation is less than the lower limit of the active operation interval of the unit, or greater than the upper limit of the active operation interval of the unit, indicating that the calibration regulation does not meet the conditions for execution, end the calibration regulation of secondary frequency modulation.
